(19) United States
(12) Patent Application Publication
(10) Pub. No.: US 2016/0006645 A1
(43) Pub. Date: Jan. 7, 2016

(54) INCREASED DATA TRANSFER RATE METHOD AND SYSTEM FOR REGULAR INTERNET USER

(71) Applicant: TERIDION TECHNOLOGIES LTD., Petach Tikva (IL)

(72) Inventor: Elad RAVE, Ramat Gan (IL)

(73) Assignee: TERIDION TECHNOLOGIES LTD., Petach Tikva (IL)

(21) Appl. No.: 14/768,596

(22) PCT Filed: Feb. 19, 2014
(86) PCT No.: PCT/IL14/50186

§ 371 Date: Aug. 18, 2015

Related U.S. Application Data
(60) Provisional application No. 61/766,123, filed on Feb. 19, 2013.

(51) Int. Cl. H04L 12/727; H04L 12/751; H04L 29/06; H04L 29/08; H04L 12/26; H04L 12/28; H04L 12/721

(52) U.S. Cl. CPC H04L 45/121; H04L 12/2854; H04L 45/02; H04L 45/123; H04L 67/2847; H04L 43/0888; H04L 67/42

(57) ABSTRACT

Method for increasing data transfer rates for regular net-work users, including the procedures of generating a WAN optimization network (WANON), in a network, defining a client, for requesting data, and an origin, from which data is requested, the WANON determining a best requesting node for the client based on a data request, configuring the client to forward the data request to the WANON, the client requesting data by forwarding the data request to the requesting node, the WANON determining a best origin node for retrieving the requested data from the origin according to a network identifier resolution of the origin, the requesting node forwarding the data request to the origin node using WAN optimization, the origin node retrieving the requested data from the origin and transferring the retrieved data to the requesting node using WAN optimization, the requesting node transferring the retrieved data to the client, and updating the WANON.

### FIELD OF THE DISCLOSED TECHNIQUE

The disclosed technique relates to WAN optimization, in general, and to methods and systems for providing significantly increased data transfer rates for regular Internet users without specialized WAN optimization hardware, in particular.

### BACKGROUND OF THE DISCLOSED TECHNIQUE

Wide area networks (WANs) connect computers together which are spread out over large distances. This may include computers located in different countries and/or continents. In general, WANs such as the Internet are spread out over continents, with computers, servers and nodes in the WAN being interconnected via a gigantic network of cables. Except for Antarctica, in which computers situated on that continent connect to the Internet via a satellite connection, all other computers connected to the Internet around the world are connected via cables. These cables may be telephone lines, power lines, a dedicated fiber optic network, underground sea cables and the like. For example, for communication between continents separated by oceans, such as from Asia to North America, data is transferred via underground sea cables connecting the two continents. Within a given landmass, such as continents like Europe and Australia, data may be transferred between computers via existing networks of cables, such as power lines or telephone lines, or via newer cables setup specifically for high data transfer rates, such as fiber optics lines like the National Broadband Network being deployed in Australia. In general, transferring data via cables is preferred to transferring data via satellite connection as transfer rates are significantly higher using cables, cables are less prone to interference and are not affected by the weather. Reference is now made to FIG. 1A, which is a schematic illustration of underground sea cables connecting continents of the world for data transfers, generally referenced 10, as known in the prior art. FIG. 1A is only illustrative and does not show all the major underground sea cables which connect the continents of the world. For example, underground sea cable 12A connects the west coast of the United States with New Zealand. Underground sea cable 12B connects New Zealand with Australia. Underground sea cables 12C connect Japan and China to the west coast of the United States. Underground sea cable 12D connects northern Europe with Canada via Iceland and Greenland. Underground sea cables 12E connect New York with England. Underground sea cable 12F connects the Dominican Republic to Morocco. Underground sea cable 12G connects South Africa to India. Underground sea cable 12H connects Indonesia to Western Australia. Underground sea cable 12I connects India to the Arabian Peninsula. Underground sea cable 12J connects various countries in South America with the state of Florida in the United States. The network of underground sea cables shown in FIG. 1A substantially represents the physically medium and network over which a majority of the data transfers of the Internet take place.

The fastest way to transfer data between two computers or two nodes in a network are for the computers or nodes to be connected directly. However, unless the computers are physically located in the same building, the computers will most probably connect via a plurality of nodes physically located between the computers. In WANs such as the Internet, the flow of data from one computer to another is dictated by the physical layout of cabling connecting the computers as well as the selected nodes via which different Internet Service Providers (herein abbreviated ISPs) transfer data nationally and internationally. For example, Israel does not have a direct underground sea cable connection with the United States, although it does have a direct underground sea cable connection to Europe via the MedNautilus and JONAH underground sea cable networks. Therefore, computers in Israel which access websites located on servers in the United States connect to those servers in the United States via nodes located in Europe.

Reference is now made to FIG. 1B, which is a schematic illustration of multiple data transfer paths between two nodes, generally referenced 20, as known in the prior art. As shown in FIG. 1B, a node 22 in Israel wants to access a node 24 in the United States. Nodes 22 and 24 may be personal computers, workstations, servers and the like. Also shown in FIG. 1B are major nodes which connect Europe to North America and Israel as well as interconnecting countries within Europe, labeled as nodes A-J. FIG. 1B is merely illustrative and only shows a few nodes and their interconnectivity. Node A is located in Crete, node B is located in Italy, node C is located in Germany, nodes D and F are located in France, nodes E and G are located in England, node H is located in Norway, node I is located in Iceland and node J is located in Greenland. Node 22 is coupled with node A. Node A is coupled with node B. Node B is coupled with nodes C and D. Node D is coupled with nodes C, E and F. Node C is coupled with nodes E and H. Node E is coupled with nodes G and H. Node F is coupled with nodes D and G and with node 24. Node G is coupled with node 24. Node H is coupled with node I, which in turn is coupled with node J. Node J is coupled with node 24.

Node 22 may represent a router belonging to an Israeli ISP whereas node 24 may represent a server belonging to an American ISP. An Internet user in Israel (not shown) may be browsing the Internet via node 22 and may select to view a website or download data, such as a movie, located in the United States via node 24. When the Internet user in Israel makes a request for the data to be transferred to her computer, node 22 must connect with node 24. As shown in FIG. 1B, node 22 can connect to node 24 via multiple paths. For example, node 22 can connect to node 24 via nodes A-B-D-F. Node 22 can also connect to node 24 via nodes A-B-C-E-G. Many other connection paths are possible. The choice of which path node 22 selects to connect with node 24 is dependent on many factors, such as the time of day the request to node 22 is made, the number of requests a given node can handle, business arrangements between nodes, the cost of accessing certain nodes, the data transfer rates between nodes and the like. For example, access between nodes B and D may be faster than access between nodes B and C, yet business arrangements may dictate that access of node B to node C is cheaper than access of node B to node D. Node 22 may in turn determine which path to request access to node 24 based on a business arrangement with the user. For example, if the user is a premium subscriber then the more expensive and quicker path (nodes B and D) may be accessed, whereas if the user is simply a regular subscriber then the cheaper and slower path (nodes B and C) may be accessed.

As shown and described in FIG. 1B, the location of a node in a WAN can significantly affect its data transfer rate depending on where in the WAN the node is located and where it wants to send information. In addition, as mentioned above, even if an optimal path between two nodes exists, various factors may prevent the optimal path from being used to connect the two nodes. For example, European ISPs may set data requests to the United States originating from European Internet Protocol (herein abbreviated IP) addresses as having a higher priority than data requests to the United States originating from IP addresses outside of Europe. Therefore, Internet users in the Middle East may experience slow data transfer rates when accessing websites and data located in the United States via Europe. Whereas given state of the art web surfing rates such slow data transfer rates may not be noticeable when viewing static websites, slow data transfer rates are noticeable when users access dynamic websites, websites receiving a lot of traffic (such as news websites) as well as websites providing access to large files (such as gigabyte size files as in full-length feature films in digital format).

In general, WANs are characterized by significantly smaller bandwidth and lower data transfer efficiencies as compared to local area networks (herein abbreviated LANs). As the world has grown more interconnected, via the Internet and other national and international WANs, and as companies have started to have offices in multiple countries, there has been a development of systems and methods for increasing the data transfer rates between nodes in such expansive WANs. For example, an airline company, which may have over a hundred branch offices around the world and thus thousands of nodes in its network, may have a WAN, such as an intranet, connecting all the nodes in all its branch offices to a central server for airline bookings. Whereas within a landmass (such as Europe) or a country (such as the United States) the airline company may deploy a private dedicated WAN with its own proprietary cables to increase the data transfers rates between nodes in that landmass or country and a server located in that landmass or country, nodes outside the landmass or country must still use existing networks of cables to access servers or communicate with nodes in the landmass or country, thus probably suffering from slow data transfer rates. To overcome such slow data transfer rates in WANs and intranets, especially in large companies, techniques, collectively known as WAN optimization techniques, have been developed. WAN optimization techniques substantially relate to systems and methods for increasing the rate of data transfers within a WAN and include techniques such as deduplication, traffic shaping, compression, protocol spoofing, latency optimization, caching and the like, all of which are known in the art. Deduplication involves eliminating the transmission of redundant data between nodes by sending references to previously handled data instead of the actual data itself. Caching involves temporarily storing repeatedly accessed web documents in a cache for rapid access. Compression involves representing data patterns more efficiently. Examples of various WAN optimization systems and techniques are shown below in FIGS. 2 and 3.

Reference is now made to FIG. 2, which is a schematic illustration of a WAN optimization system, generally referenced 30, as known in the prior art. FIG. 2 shows a simplified network of an airline company with a branch office 32A in Europe, a branch office 32B in the United States (herein referred to as America, the United States of America, the US or the USA) and a branch office 32C in the Middle East. Each branch office may have a server (not shown) for keeping track of airline bookings. Due to the physical location of the branch offices and the time differences between them, the airline company may need to handle airline bookings around the clock and thus the servers in each of the branch offices need to be constantly kept up-to-date about various flight bookings of the airline made at each branch office. In order to speed up data transfer rates between the branch offices such that all servers are up-to-date, the airline company has deployed hardware using a known WAN optimization technique, such as deduplication. In general, WAN optimization techniques may be implemented using specific hardware or specific software running on the servers of a WAN. Therefore, as shown in FIG. 2, each branch office is connected to each other branch office via a WAN (not labeled), where access of nodes (not shown) in each branch office to the WAN is via WAN optimization hardware. The WAN in FIG. 2 is an intranet. Branch office 32A is coupled with WAN optimization hardware 34A via connection 42A, which couples branch office 32A to the WAN. Branch office 32B is coupled with WAN optimization hardware 34B via connection 42B, which couples branch office 32B to the WAN. Branch office 32C is coupled with WAN optimization hardware 34C via connection 42C, which couples branch office 32C to the WAN. As shown, each branch office does not communicate directly with another branch office; direct communication is done via the WAN optimization hardware, as shown by arrows 44A-44F.

WAN optimization hardware 34A, 34B and 34C may each be a physical device attached to the main server in each of branch offices 32A, 32B and 32C. Therefore any data to be transferred between one branch office and another is sent and received via the WAN optimization hardware. It is noted that WAN optimization hardware 34A, 34B and 34C is usually proprietary and since no international protocols exist for performing WAN optimization, WAN optimization hardware 34A, 34B and 34C must be from the same company. Known companies which manufacture WAN optimization hardware include Bluecoat, Riverbed, Cisco and Radware. Therefore, the airline company shown in FIG. 2 must purchase all their WAN optimization hardware from the same company as otherwise there is no guarantee that a piece of WAN optimization hardware from Riverbed can communicate with a piece of WAN optimization hardware from Cisco. It is noted that the WAN optimization hardware shown in FIG. 2 can also be embodied as software run on the main servers (not shown) of each branch office. Yet in this case as well, the software run on each server must be either the same software or from the same company to ensure intercompatibility and interoperability.

FIG. 2 shows WAN optimization hardware 34A-34C using only the deduplication WAN optimization technique. It is noted that many other WAN optimization techniques exist, as mentioned above, and WAN optimization hardware 34A-34C could use any and all of those techniques for increasing the data transfer rates between branch offices 32A-32C. The deduplication WAN optimization technique (herein referred as DEDUP) substantially eliminates the transfer of redundant information across a WAN by sending references to data instead of actual data. To achieve this, each piece of WAN optimization hardware is coupled with a hash table for each other branch office it communicates with. Each hash table stores blocks of data as references in a type of dictionary constructed in real-time between the WAN optimization hardware of two branch offices. As shown in FIG. 2, WAN optimization hardware 34A includes a hash table 1 36₁ and a hash table 2 36₂. WAN optimization hardware 34B includes a hash table 1 38₁ and a hash table 3 38₂. WAN optimization hardware 34C includes a hash table 2 40₁ and a hash table 3 40₂. Hash table 1 36₁ and hash table 1 38₁ are used for eliminating redundant data transferred between WAN optimization hardware 34A and 34B. Hash table 2 36₂ and hash table 2 40₁ are used for eliminating redundant data transferred between WAN optimization hardware 34A and 34C. Hash table 3 38₂ and hash table 3 40₂ are used for eliminating redundant data transferred between WAN optimization hardware 34B and 34C. As can be seen, each branch office requires a specific hash table for using DEDUP with another branch office as the entries in the hash tables of two branch offices communicating with one another need to be kept constantly consistent. In FIG. 2, each branch office communicates with two other branch offices, therefore each branch office requires two hash tables. In reality, an airline company with a hundred branch offices around the world may require each branch office to store a hundred hash tables for communication with each other branch office in the airline company's WAN using DEDUP to speed up data transfer rates.

Reference is now made to FIG. 3, which is a schematic illustration of another WAN optimization system, generally referenced 60, as known in the prior art. FIG. 3 shows a news company, located in the US, which runs a news website (not shown), hosted by a news company server 62 (herein referred to as server 62) also located in the US. The news company could be for example Fox News, CNN, ABC News and the like. News websites in general are very dynamic and are updated constantly with new images, new videos and new stories. News websites also receive large amounts of Internet traffic which may slow down the server or servers hosting such types of websites. Internet users the world over, such as a user 66 in Tunisia, a user 68 in Madagascar, a user 70 in Russia, a user 72 in Germany and a user 74 in Canada, may access the news website of the news company via server 62.

As users 66, 68, 70, 72 and 74 are not located in the US, one method of accessing server 62 would be for each user to make requests of server 62 directly via a plurality of nodes connecting the computers (not shown) of each of users 66, 68, 70, 72 and 74 to server 62. As mentioned above, many factors can influence the data transfer rates between two nodes in a WAN. As users 66, 68, 70, 72 and 74 may need to access multiple nodes to send a request for data to server 62 and as server 62 may have a lot of Internet traffic and may also have to transfer large amounts of data to any one of users 66, 68, 70, 72 and 74 depending on the type of data requested, users 66, 68, 70, 72 and 74 may experience relatively slow data transfers rates between their respective computers and server 62.

Another method for accessing server 62 is shown in FIG. 3 and is a form of WAN optimization known as using a content distribution network (herein abbreviated CDN). The CDN of FIG. 3 includes a plurality of reverse proxy servers, also known as proxies for short, which communicate directly with server 62. Herein the term ‘proxy’ refers to a reverse proxy unless otherwise noted. Reverse proxies retrieve data and resources from servers on behalf of clients and users. In addition, from the point of view of a client or user, when data is retrieved by a reverse proxy from a server and transferred to the client or user, the data appears to the client or user to have originated from the server, even if the data originated in the reverse proxy. As shown, the CDN includes a proxy 64A, located in England, a proxy 64B, located in Poland, a proxy 64C, located in Egypt, a proxy 64D, located in India, a proxy 64E, located in Japan, a proxy 64F, located in Australia, a proxy 64G, located in South Africa and a proxy 64H, located in Chile. Each one of proxies 64A-64H can communicate directly with server 62. Known WAN optimization techniques, as described above in FIG. 2, may be used to increase the data transfer rates between server 62 and each one of proxies 64A-64H. Such WAN optimization techniques are possible as proxies 64A-64H may be owned or run by the news company and together with server 62 form an intranet for the news company. Proxies 64A-64H substantially store copies of data frequently requested from server 62. In this sense, data, or content, located on server 62 is distributed over the intranet of the news company via proxies 64A-64H.

When a user requests data from server 62, the request for data may travel via one of proxies 64A-64H en route to server 62. If the requested data is stored in one of proxies 64A-64H, then the user retrieves the data from the respective one of proxies 64A-64H and not from server 62. As noted above, in such a scenario, the data will appear to the user to have been retrieved from server 62. In general, proxies 64A-64H are situated in specific geographic locations around the world where the news company may have determined that a significant number of users attempt to regularly access server 62. By having users retrieve data from one of proxies 64A-64H instead of from server 62 directly, Internet traffic is diverted away from server 62, thus increasing the ability of server 62 to deal with multiple data requests. In addition, users can retrieve data from a physical location which is closer to where they are situated, as proxies 64A-64H are physically located in different geographic locations, thus increasing the data transfer rate to users by reducing the number of nodes required to connect the user to server 62.

For example, user 72 in Germany may make a request for data from server 62. A local server (not shown) in Germany receiving the request from user 72, may determine that server 62 has a proxy server in Poland, proxy 64B. The local server will then send the data request of user 72 to proxy 64B. If proxy 64B has the requested data, then proxy 64B will transfer the data to user 72 via the local server. In this case, user 72 will receive the requested data at a higher data transfer rate than from server 62 directly since the request is being answered by a server, proxy 64B, which is physically much closer to where user 72 is located as compared to the distance between user 72 and server 62. If proxy 64B does not have the requested data, proxy 64B may request the data from server 62 on behalf of user 72 or proxy 64B may sent a message to the local server that it should request the requested data from server 62 directly. Similar scenarios may happen for users 66, 68 and 70 making requests from server 62. In the case of user 74 in Canada, a request for data from server 62 may be sent directly to server 62 as each one of proxies 64A-64H are not geographically located closer to user 74 than server 62.

In general, systems using a CDN substantially break up the transfer of data between two nodes in a WAN into two separate communication channels. As shown in FIG. 3, server 62 mostly communicates directly with proxies 64A-64H and proxies 64A-64H mostly communicate directly with users 66, 68, 70, 72 and 74. As server 62 is updated with new content, such as a breaking news story, the new content is distributed and transferred to proxies 64A-64H, which store a local copy of the new content. Users interested in the breaking news story will communicate with proxies 64A-64H to get the new content transferred to their computers.

Other known systems and methods of WAN optimization are known in the art. For example, US Patent Application Number 2010/0146074 A1, issued to Srinivasan and entitled “Network optimization using distributed virtual resources” is directed to a distributed system for WAN optimization. Srinivasan's system comprises a virtual appliance that includes a plurality of local computing devices (herein referred to as local devices). Each of the local devices includes a number of resources such as a processor, a memory or cache and a disk. Each of the local devices is also provided with a virtualization software which includes a virtualization software switch. Additionally, the system of Srinivasan includes a distributed WAN optimization application which is comprised of local WAN optimization applications running on one or more of the local devices. The local devices communicate with each other via a LAN, a WAN, a node-to-node or a device-to-device connection. The virtual appliance is coupled via a WAN to a remote device.

A virtualization software on a local device allocates at least a portion of the resources of the local device to the virtual appliance. The local WAN optimization applications run on the local devices via the virtual machines. The virtualization software switch forwards or redirects traffic to and from the local device to the distributed WAN optimization application. Data handled by the virtualization software switch may be stored in a distributed database that includes resources of one or more local devices. The WAN optimization applications use the data stored in the distributed database to perform various tasks such as Internet caching and data segment caching, in which data segments and a data signature for each data segment are stored in the distributed database.

In an aspect of Srinivasan's system, a local device may request data from a remote device. The virtualization software switch forwards or redirects the requested data to the distributed WAN optimization application which stores the data in the distributed database. The distributed WAN optimization application may receive a request from a second local device to receive data from a remote device wherein the requested data is stored in the distributed database. The request is then fulfilled based on the data stored in the distributed database. In another aspect of Srinivasan's system, the distributed WAN optimization application stores a segment signature for each data segment transmitted to a remote device in the distributed database. A local device may receive a request to transmit data segments to a remote device. The virtualization software switch at the local device forwards the request to the distributed WAN optimization application which determines, by looking-up in the distributed database, whether at least one of the requested data segments was previously transmitted to the remote device. If one or more of the requested data segments were already transmitted, the distributed WAN optimization application transmits the stored signatures of those data segments to the remote device instead of the actual data segments.

US Patent Application Number 2011/0179341 A1, issued to Falls et al. and entitled “Method and apparatus for compression and network transport of data in support of continuous availability of applications” is directed to a system and method for compressing data transmitted between nodes in a network facilitating continuous availability of applications supported by the network. The system of Falls is comprised of a computer system having a source node and a target node and may include additional nodes as well. Each node is a physical or virtual computer system. Each node includes multiple applications, a data protection block, a network communication block and a disk. Additionally, the source node includes a compression block and the target node includes a decompression block.

The two nodes are connected to each other via at least one network and may also be providing services to client computers via a network. Applications executed by the source node are configured by the network communication block to be visible to client computers via the network. The data used by applications that is designated as “protected applications” is replicated to the disk of the target computer. The data protection block on the source node intercepts some of the write operations to the disk on the source node by the applications. The data protection block also defines which data used by the applications is to be protected (i.e. replicated on the disk of the target node). The network communication block on the source node sends these write operations to the network communication block on the target node. The data protection block on the target node executes the write operations to the disk on the target node. Before the data is sent from the source node it is compressed by the compression block on the source node and after it is received at the target node it is decompressed by the decompression block on the target node.

The system employs three different modes of compression, repeat pattern replacement (herein abbreviated RPR), deduplication and deflate. In the RPR mode, the source data is searched for consecutive occurrences of similar patterns of symbols of relatively short length (e.g., 3 symbols). These consecutive occurrences of patterns of symbols are then replaced with an RPR item which identifies the pattern of symbols and the number of occurrences. The deduplication mode of compression employs a hashed signature comparison to identify a recurrence of a pattern in the source data, where a signature is a fixed length range within the source data. For the comparison, the deduplication mode utilizes a dictionary of prior hash signatures where each entry is associated with a chunk of data whose length is equal to or greater than the signature length. The dictionary entry contains an offset to its associated chunk of data in a “reference log” which is a partial history of the source data after RPR processing. A portion of the reference log is re-created in the target node. Once a recurrence of a pattern is found and validated, the recurrent pattern is replaced with a deduplication item which includes the starting point within the reference log from which a string will be copied and the number of symbols to be copied. The deflate mode of compression is carried out in two blocks. The first performs a sliding window compression where recurrent patterns occurring within the deflate view range are found. These patterns can be consecutive or non-consecutive with a length that is shorter than the signature length of the deduplication mode of compression. A recurrent pattern is replaced with a pointer to the original occurrence of the pattern and its length within the deflate view window. The second block within the deflate mode of compression performs entropy coding which compresses data by using fewer bits to encode more frequent characters.

US Patent Application Number 2008/0281908 A1, issued to McCanne et al. and entitled “Hybrid segment-oriented file server and WAN accelerator” is directed to a system for performing file data manipulations over a constrained bandwidth and high latency network. The system of McCanne includes a plurality of client-side WAN accelerators (herein referred to as client-side accelerators), a plurality of server-side WAN accelerators (herein referred to as server-side accelerators), a plurality of segment-oriented file server protocol (herein abbreviated SFS) gateways and a plurality of file servers. Additionally the system of McCanne includes SFS servers and disk arrays. The WAN accelerators, both the client-side accelerators and the server-side accelerators, are connected to each other via a WAN. Each of the client-side accelerators is connected to one or more client computers. Each of the server-side accelerators is connected to an SFS gateway. One or more file servers are connected to each server-side accelerator as well as to its SFS gateway. Additionally, each server-side accelerator may be connected to one or more SFS file servers. Each SFS file server is connected to a disk array.

Client computers access files stored on the file servers by using the WAN accelerators and the SFS gateways. An SFS gateway exports one or more file shares that are stored on the file servers connected to it. A client computer mounts one of the export file shares via a transport connection which is optimized by WAN accelerators. Accessing and manipulating files is carried out via the SFS gateways rather than over the WAN accelerated file connection directly to the file server. Since the WAN accelerators are SFS-aware, they intercommunicate with the SFS gateway using SFS and not a legacy file protocol (e.g., CIFS or NFS). In the system of McCanne, the SFS file server may manage its own file system on a raw volume directly. The file system may be located on the disk array and accessed over a storage-area network.

The SFS gateway and SFS servers represent files not as data blocks but with a “data map” which defines a file in terms of the same “language” used by the WAN accelerators to communicate data to one another. The SFS data map provides a description of the data that underlies a file. A data map is associated with each file on the file server and induces a separation between the structure of the file including its metadata and the actual data it contains. Using the system, a file can be transported across the network by sending the file's data map instead of its entire contents.

U.S. Pat. No. 7,865,585 B2, issued to Samuels et al. and entitled “Systems and methods for providing dynamic ad hoc proxy-cache hierarchies” is directed to a system for storing previously transmitted data and using it to reduce bandwidth usage and accelerate future communications. The system of Samuels includes three or more WAN optimization appliances (herein referred to as appliances), one server side appliance and two or more client side appliances. The server side appliance is connected to a server via a LAN. The client side appliances are connected to each other via a second LAN. The second LAN also connects each of the client side appliances to one or more clients. The server side appliance and the server may be located in a central office while the clients and the client side appliances may be located in one or more branch offices. The server side appliance and the client side appliances are connected via a WAN.

In response to a request from a client for data from the server, the server side appliance transmits the data to a first one of the client side appliances. As the data is being transmitted the two appliances store copies of the data. The stored copies of the data in each of the appliances are referred to as compression histories. The server side appliance may then receive a request from a second client side appliance, originating from another client, for data from the server. The server side appliance passes the request to the server. Upon receiving the data from the server, the server side appliance may detect one or more matches between the received data and data stored in the compression history. These matches indicate that the requested data had been previously transmitted to the first client side appliance. The server side appliance then transmits the requested data to the second client side appliance compressed according to the compression history shared with the first client side appliance. The second client side appliance then requests the data from the first client side appliance which transmits the requested data portions to the second client side appliance. The data transmitted from the first client side appliance may also be stored in the compression history of the second client side appliance. The data is then sent to the client which requested it.

### SUMMARY OF THE DISCLOSED TECHNIQUE

The disclosed technique overcomes the disadvantages of the prior art by providing novel methods and a novel system for increasing the data transfer rates of regular Internet users without those users requiring specialized WAN optimization hardware, software or both.

According to one aspect of the disclosed technique, there is thus provided a method for increasing a data transfer rate for a regular network user. The method includes the procedures of generating a WAN optimization network of at least two server nodes and in a network, defining at least two nodes, at least one of the nodes being a client, for requesting data, and at least another one of the nodes being an origin, from which the data is requested from. The method also includes the procedures of the generated WAN optimization network determining a best requesting node for the client based on a data request, the best requesting node being selected from the server nodes, configuring the client to forward the data request to the generated WAN optimization network and the client requesting data from the origin by forwarding the data request to the determined best requesting node. The method further includes the procedures of the generated WAN optimization network determining a best origin node, from the server nodes, for retrieving the requested data from the origin according to at least one network identifier resolution of the origin, the best requesting node forwarding the data request to the best origin node using a first at least one WAN optimization technique, the best origin node retrieving the requested data from the origin and transferring the retrieved data to the best requesting node using a second at least one WAN optimization technique, the best requesting node transferring the retrieved data to the client, and updating the WAN optimization network.

According to another aspect of the disclosed technique, there is thus provided another method for increasing a data transfer rate for a regular network user, including the procedures of generating a WAN optimization network of at least two server nodes and in a network, defining at least two nodes, at least one of the nodes being a client, for requesting data, and at least another one of the nodes being an origin, from which the data is requested from. The method also includes the procedures of the generated WAN optimization network determining a best requesting node for the client based on a data request, the best requesting node being selected from the server nodes, configuring the client to forward the data request to the generated WAN optimization network and the client requesting data from the origin by forwarding the data request to the determined best requesting node. The method further includes the procedures of the generated WAN optimization network determining a best origin node, from the server nodes, for retrieving the requested data from the origin according to at least one network identifier resolution of the origin, the best requesting node forwarding the data request to the best origin node using at least one WAN optimization technique and the best origin node retrieving the requested data from the origin. The method also includes the procedures of if the retrieved data is cache enabled and has not yet expired, then the best origin node determines if the retrieved data can be reconstructed from the generated WAN optimization network, the best origin node then forwarding a message to the generated WAN optimization network to reconstruct the retrieved data from at least one distributed data structure (DDS), the best request node reconstructing the retrieved data from its own DDS and transferring the retrieved data to the client, and updating the WAN optimization network.

According to a further aspect of the disclosed technique, there is thus provided a WAN optimization system for use with a network, the network including at least two nodes, at least one of the nodes being a client, for requesting data, and at least another one of the nodes being an origin, from which the data is requested from. The WAN optimization system includes at least two server nodes, coupled together so as to transfer data therebetween using at least one WAN optimization technique. The WAN optimization system determines a best requesting node and a best origin node, from the server nodes, for the client based on a data request and on at least one network identifier resolution of the origin. The client forwards the data request to the determined best requesting node which forwards the data request to the best origin node using the WAN optimization technique. The best origin node retrieves the requested data from the origin and transfers it back to the best requesting node, using the WAN optimization technique, and the best requesting node transfers the retrieved data to the client.

### BRIEF DESCRIPTION OF THE DRAWINGS

The disclosed technique will be understood and appreciated more fully from the following detailed description taken in conjunction with the drawings in which:

FIG. 1A is a schematic illustration of underground sea cables connecting continents of the world for data transfers, as known in the prior art;

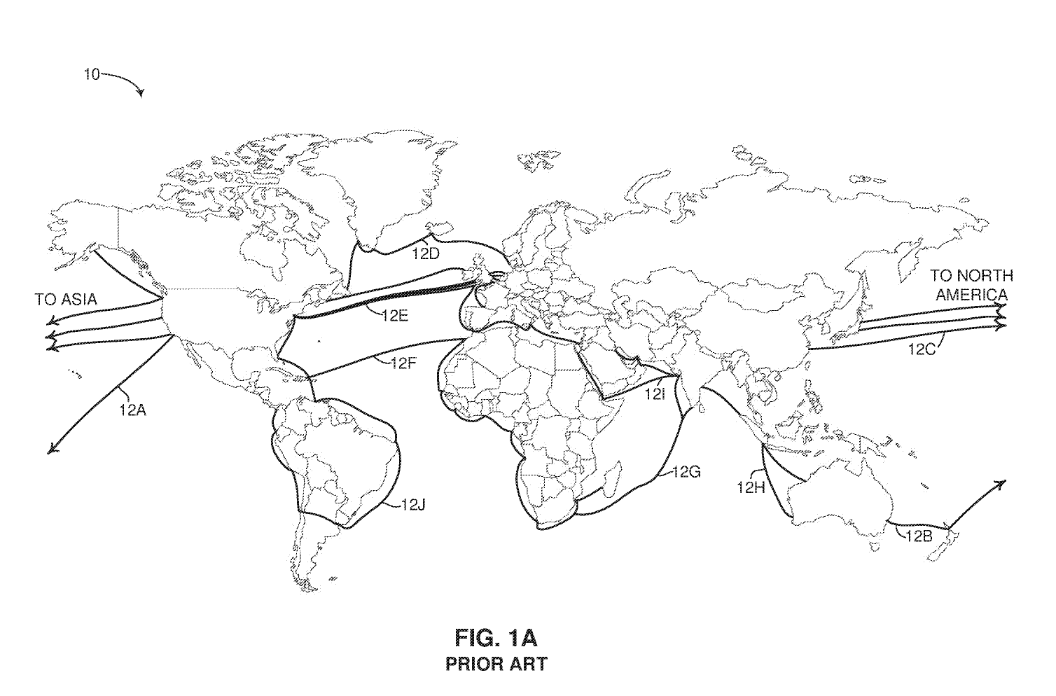

FIG. 1B is a schematic illustration of multiple data transfer paths between two nodes, as known in the prior art;

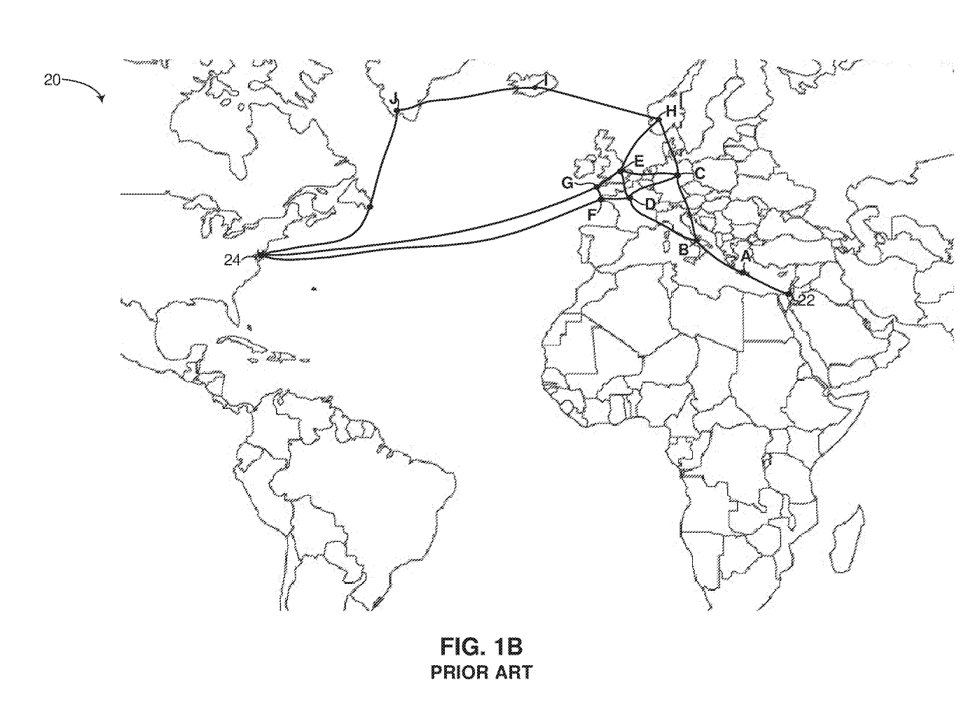

FIG. 2 is a schematic illustration of a WAN optimization system, as known in the prior art;

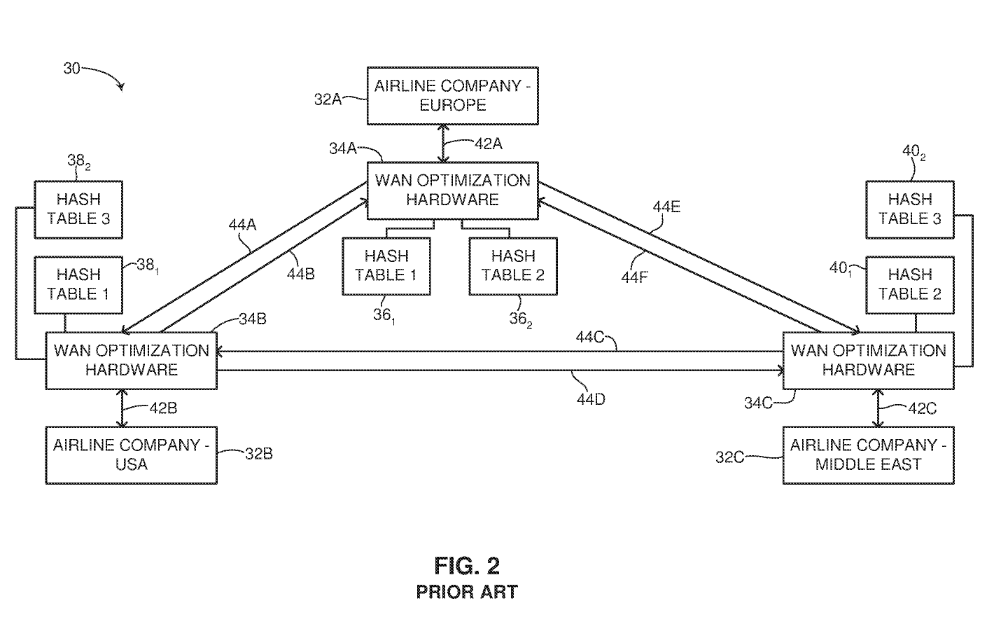

FIG. 3 is a schematic illustration of another WAN optimization system, as known in the prior art;

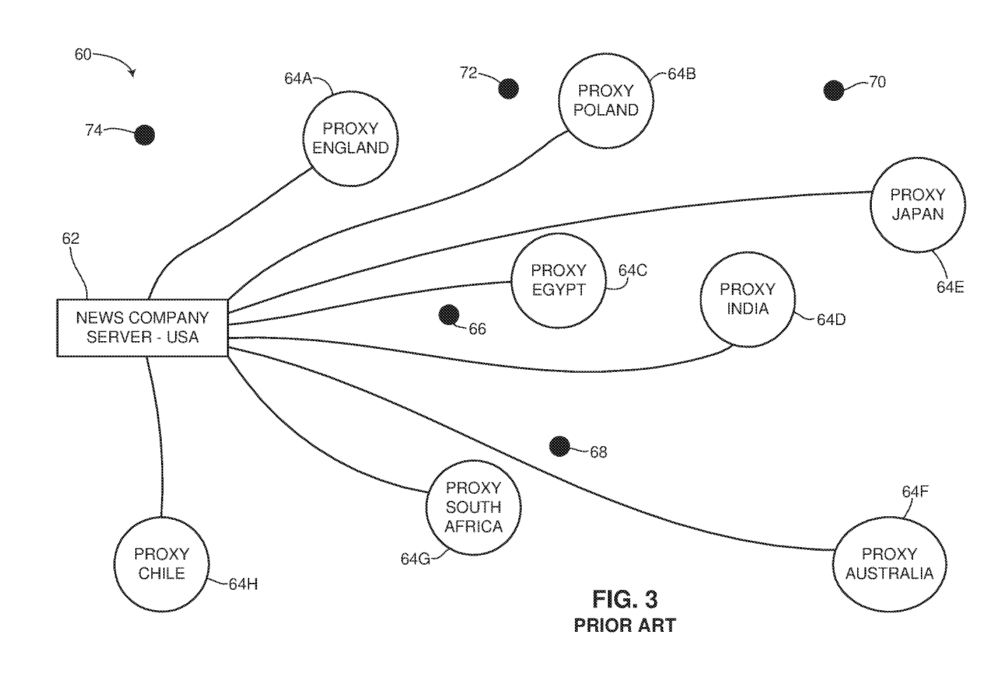

FIG. 4A is a schematic illustration of a WAN optimization system and network, constructed and operative in accordance with an embodiment of the disclosed technique;

FIG. 4B is a schematic illustration of the WAN optimization system and network of FIG. 4A, showing a data transfer between two nodes, constructed and operative in accordance with another embodiment of the disclosed technique;

FIG. 4C is a schematic illustration of the WAN optimization system and network of FIG. 4A, showing a data transfer between two nodes using clustering, constructed and operative in accordance with a further embodiment of the disclosed technique;

FIG. 5A is a schematic illustration of a first WAN optimization method, operative in accordance with another embodiment of the disclosed technique; and

FIG. 5B is a schematic illustration of a second WAN optimization method, using caching, operative in accordance with a further embodiment of the disclosed technique.

### DETAILED DESCRIPTION OF THE EMBODIMENTS

The disclosed technique overcomes the disadvantages of the prior art by providing a novel system and method for increased data transfer rates (also referred to herein as simply data rates) for a regular Internet user. In the description of the disclosed technique, the following terminology will be used to distinguish the various procedures and systems of the disclosed technique. As mentioned above, a WAN, such as the Internet, is comprised of a plurality of nodes and their interconnectivity. In general, nodes may either be requesting data or may be the location in which requested data is stored. Any regular Internet user, or node, accessing the Internet with a data request will be referred to as a client. Clients can also be referred to as user nodes in a network. Clients represent regular Internet users around the world accessing the Internet from various physical locations and making requests for data. Clients may be personal computers, workstations, smartphones or other devices capable of accessing the Internet and performing data requests. Clients may also be various types of servers which merely pass on a data request which originated from a user node. Any node storing data from which a client may request that data will be referred to as an origin. Origins represent nodes in the Internet from which a user may request data. Typically, origins represent websites, servers, mail servers, proxy servers, cloud servers, cloud routers and the like from which a user may request a data transfer from. Thus, clients request data from origins and data transfers occur between origins and clients. In the disclosed technique, as described below, a group of nodes is defined which forms a WAN optimization system for increasing the transfer rates of data between an origin and a client. These nodes will be referred to as server nodes. According to the disclosed technique, two types of server nodes are defined in the WAN optimization system. A request node represents a server node which is best for a client and an origin node represents a server node which is best for an origin. The term ‘best’ in this context is defined below. A server node can act as both a request node and an origin node.

The system of the disclosed technique includes a worldwide network of server nodes which are coupled together via either WAN optimization hardware, WAN optimization software or both. Clients access the network of server nodes for data transfer requests instead of directly making requests from origins. In particular, a client sends a data request to a request node. The request node forwards the data request to an origin node. The origin node retrieves the requested data from the origin and transfers it back to the request node which forwards the retrieved data back to the client. Each server node (i.e., request nodes and origin nodes) may maintain a single distributed data structure (herein abbreviated DDS). The DDS may store information relating to data transferred through it to clients who have requested data from it either directly (request node) or indirectly (origin node), as explained below. The DDS of each server node is regularly updated. The DDS may also include a table of values from which the requested data may be reconstructed and is updated each time a server node (either a request node or an origin node) handles a data request. It is also noted that the requested data may be located in more than one location in the Internet. The DDS may further store information regarding the topology of the server nodes in the WAN optimization system of the disclosed technique.

For each data transfer request, a request node forwards the data transfer request to an origin node, which then retrieves the requested data from an origin. The retrieved data may be compressed and optimized by the origin node before being transferred to the request node which then decompresses the retrieved data and forwards it to the client which initially requested the data. According to one embodiment of the disclosed technique, a request node may check to see if it has previously handled the data request and if the data of the request was cached. If so, then the request node can reconstruct the requested data from its DDS and transfer it to the client. If not, then the request node determines an origin node for retrieving the requested data from an origin. According to another embodiment of the disclosed technique, the origin node may retrieve all the requested data from the origin and may transfer it to the request node which transfers the retrieved data to the client. According to a further embodiment of the disclosed technique, the origin node may determine that parts of the requested data can be reconstructed from the DDS of the request node. In such a scenario, the origin node may only retrieve the requested data from the origin which the request node cannot reconstruct from its DDS and transfer it to the request node. The request node then reconstructs the requested data from its DDS and the data received from the origin node and then transfers it to the client. According to another embodiment of the disclosed technique, if the data requested by a first request node has been requested by a different client via a second request node from the same origin node, then the origin node may instruct the first request node to retrieve the requested data from the second request node if the data was cached. The first request node and the second request node may form a cluster. According to a further embodiment of the disclosed technique, if the requested data is physically located in various parts of the world (for example, if the origin has proxy servers throughout the Internet, also known as CDN nodes), then the origin node may instruct the request node to retrieve the requested data via another origin node which is best for retrieving the requested data. The requested data may be retrieved by the other origin node from a proxy server. The other origin node may be physically closer to the request node than the distance between the request node and the origin node. In addition, the other origin node may be able to retrieve the requested data from the proxy server quicker than the origin node can retrieved the requested data from the origin. In general, according to the disclosed technique, all data requests from a client are forwarded to an origin, unlike in a CDN. Once the requested data is retrieved from an origin by an origin node, the retrieved data is transferred back to the client via a request node. According to some embodiments of the disclosed technique, if previously requested data can be cached locally on a request node and the data has not yet expired, then similar to a CDN, once an origin node has retrieved the requested data, the requested data or portions of it may be forwarded by a request node directly to a client without the origin node having to forward the retrieved data to the request node. The request node may be able to forward the requested data, or portions of it, from its cache to the client. However, even in this embodiment, the initial data request of the client is always forwarded all the way to the origin, even if the requested data may be already cached on the request node when the initial data request is made.

According to the disclosed technique, a regular Internet user benefits from the advantages of WAN optimization hardware and software without having to purchase proprietary hardware or software, since data transfers between server nodes in the worldwide network of the disclosed technique, i.e. data transfers between request nodes and origin nodes, are executed using WAN optimization hardware and software. Prior art WAN optimization techniques are generally only practically useable in intranets, such as those set up for large companies or governmental organizations, since any two nodes in such a network must use the same hardware or software for implementing the WAN optimization techniques. According to the disclosed technique, a user benefits from the advantages of a WAN optimized network since the disclosed technique provides a system and method to send data transfer requests to the server nodes of the worldwide network. Also, the server nodes of the disclosed technique are not limited to specific companies therefore any data request by a user can be transferred such that at least a significant part of the path between the location of the data and the node which requested it is traversed using WAN optimization hardware and software. In addition a regular Internet user experiences significantly increased data transfer rates according to the disclosed technique as requested data is downloaded and transferred from a determined closest location of the requested data, i.e. an origin node. It is known that the quality of service (herein abbreviated QoS) of routers can result in a sizeable loss of data. This sizeable loss may be as much as 30% depending on the brand of router used. In prior art systems, multiple routers may be involved in transferring data from a server to a user, thus resulting in significant data loss and a significantly lower data transfer rate. According to the disclosed technique, the number of routers accessed between an origin and a client is minimized, thus resulting in less data loss and a significantly higher data transfer rate. It is also noted that the disclosed technique may be implemented entirely using only software. In such an embodiment, only WAN optimization software is used.

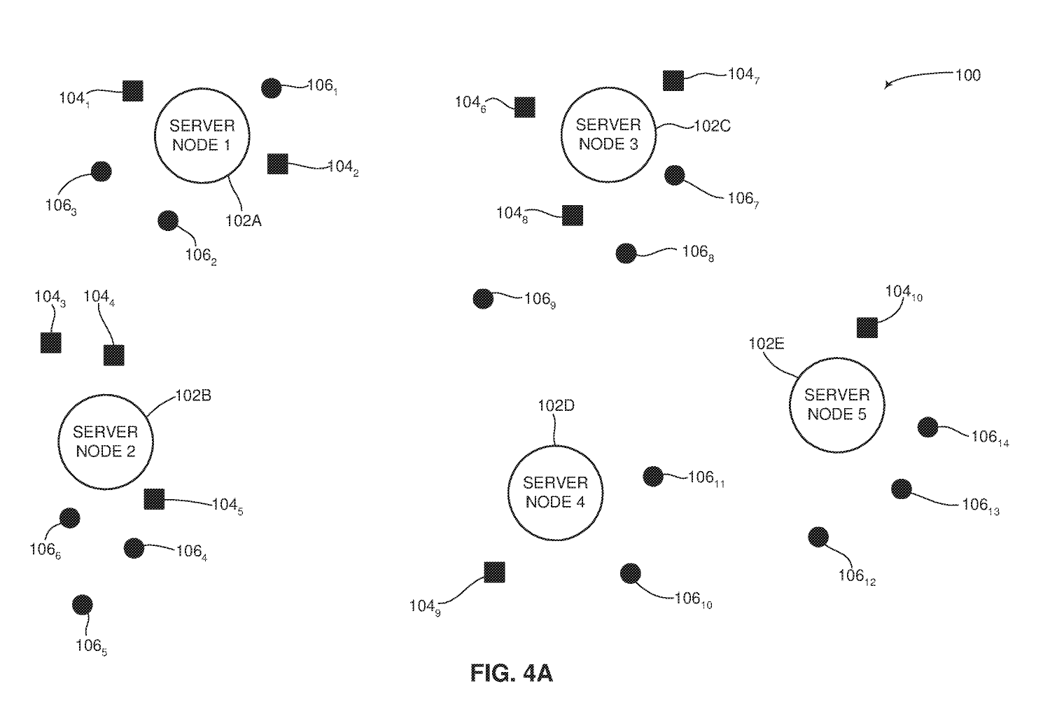

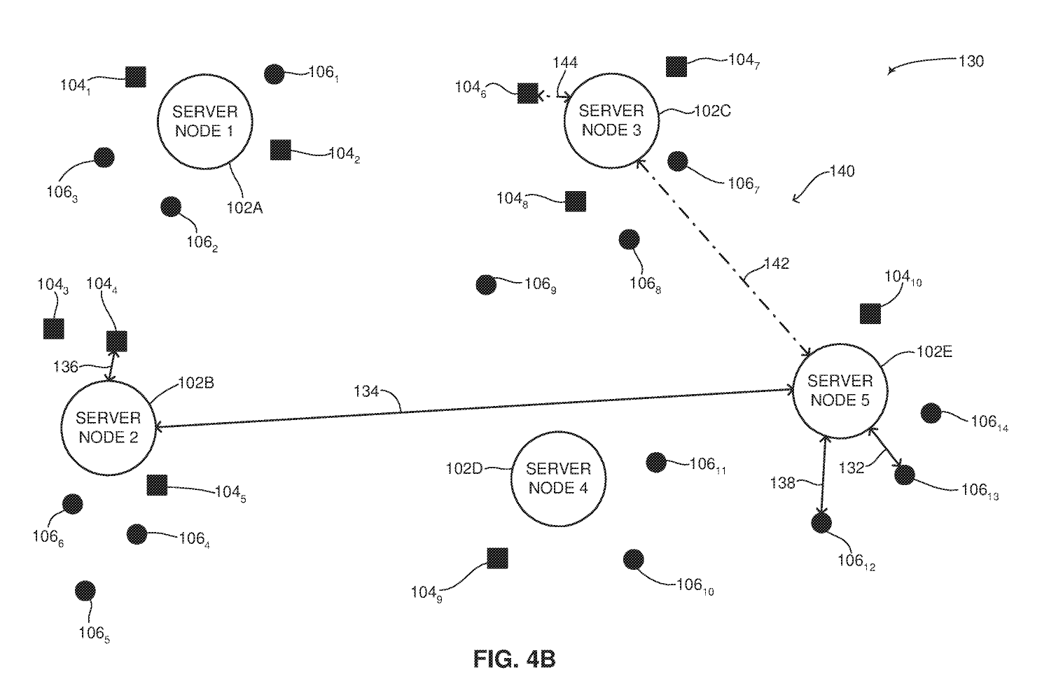

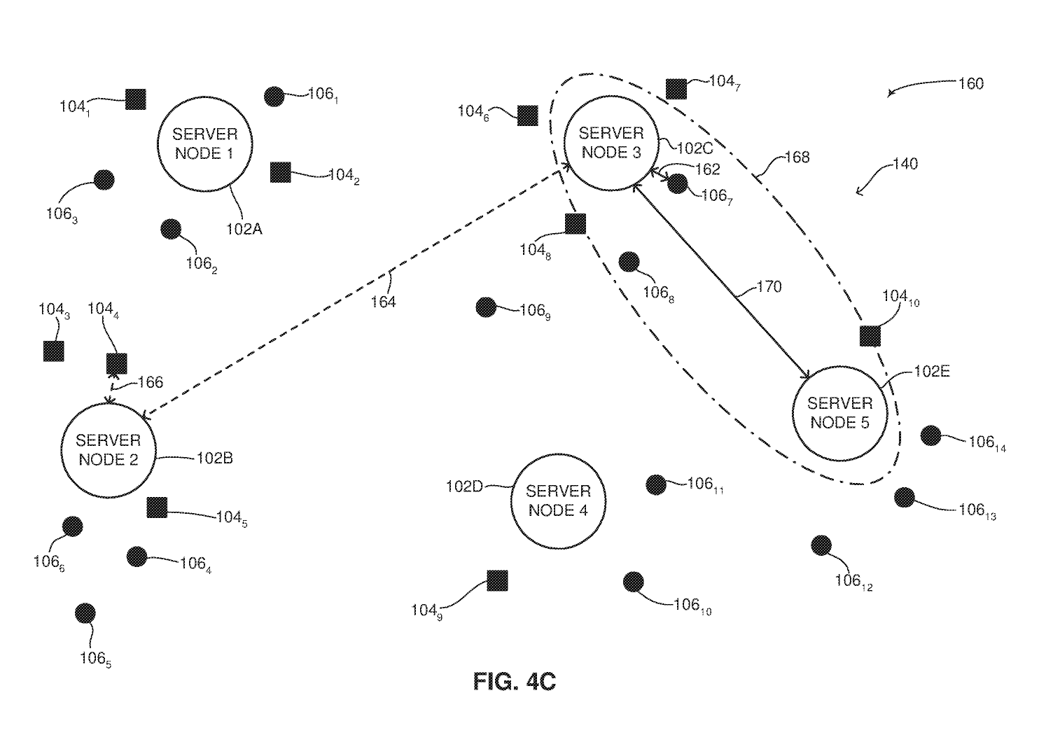

Reference is now made to FIG. 4A, which is a schematic illustration of a WAN optimization system and network, generally referenced 100, constructed and operative in accordance with an embodiment of the disclosed technique. WAN optimization system 100 includes a wide area network including a plurality of server nodes 102A, 102B, 102C, 102D and 102E. Each one of server nodes 102A-102E is located in a physically different location in the world. For example, server node 102A is located in Canada, server node 102B is located in the US, server node 102C is located in Germany, server node 102D is located in Morocco and server node 102E is located in Israel. Each one of server nodes 102A-102E is merely illustrative and may represent a plurality of individual servers which are coupled together. Server nodes 102A-102E are coupled together via the Internet. Server nodes 102A-102E are coupled like regular nodes in a WAN and may transfer data via pre-existing power line cables, underwater sea cables, telephone cables and the like. Each one of server nodes 102A-102E may act as a request node or an origin node. Each server node includes a single DDS (not shown). The DDS may be embodied as a distributed hash table (herein abbreviated as DHT), a distributed graph, a distributed linked list, a distributed array and the like. The DDS may store a table of values from which requested data may be reconstructed or may store data necessary for performing various WAN optimization techniques, such as DEDUP. The DDS may also store configuration information related to WAN optimization system 100, such as the location of server nodes 102A-102E, if other nodes join or disconnect from WAN optimization system 100, the topology of WAN optimization structure 100, and the like. Server nodes 102A-102E may each include known WAN optimization hardware (not shown), WAN optimization software (not shown) or both. As such, server nodes 102A-102E can transfer data between themselves at a significantly high data transfer rate.

FIG. 4A also shows other various nodes which are coupled with the Internet but which do not form a part of the WAN optimization system 100. Shown are origins 104₁-104₁₀ and clients 106₁-106₁₄. As mentioned above, origins 104₁-104₁₀ each represent a node in the Internet from which a client may request data. Each of origins 104₁-104₁₀ is located in a different part of the world. The relative positions of origins 104₁-104₁₀ in FIG. 4A represent their relative positions to server nodes 102A-102E. For example, origin 104₂ may be located in Ottawa, Canada, whereas origin 104₅ may be located in Austin, Tex. in the US. Therefore, origin 104₂ is substantially closer to server node 102A which is located in Canada than to server node 102D which is located in Morocco. Clients 106₁-106₁₄ represent regular Internet users around the world accessing the Internet from various physical locations. For example, client 106₇ may be located in Poland, client 106₈ may be located in Italy and client 106₉ may be located in France. It is noted that for the purposes of simplicity and to explain the disclosed technique, only a few origins and clients are shown in FIG. 4A and further on in FIGS. 4B-4C. In reality, the Internet includes billions of origins and clients.

According to the prior art, a client, such as client 106₁₁, making a data request from an origin, such as origin 104₈, would send a request directly to origin 104₈ via whatever data path (not shown) is available to client 106₁₁. For example, if origin 104₈ is a news server and happens to have a proxy server (not shown) closer to client 106₁₁, then the data request from client 106₁₁ may be redirected to the proxy server. As explained below in FIGS. 4B-4C, according to the disclosed technique, when a client makes a data request from an origin, the server node in WAN optimization system 100 which is best for the client is determined. This server node was defined above as a request node and represents the request node for that client. The term ‘best’ as used in this context is explained below. The data request of the client is then forwarded to the request node which then handles all further communication in retrieving the requested data and providing it to the client.

Reference is now made to FIG. 4B, which is a schematic illustration of the WAN optimization system and network of FIG. 4A, showing a data transfer between two nodes, generally referenced 130, constructed and operative in accordance with another embodiment of the disclosed technique. Similar elements in FIGS. 4A and 4B are labeled using identical numbering. In FIG. 4B, client 106₁₃ makes a data transfer request of origin 104₄. Client 106₁₃ is located in Israel, whereas origin 104₄ is located in the US. For example, client 106₁₃ may have requested to download a video stored in origin 104₄. In any data request, data is requested to be transferred from one location in the Internet to another. As such, clients and origins must each have a unique ‘address’ in the Internet by which they can be located and identified. This unique address can be known as a network identifier, which uniquely identifies the location of a client and an origin in the Internet. Various types of network identifiers exist and are in use in the Internet. For example, a widely used network identifier system in the Internet is the domain name system (known by its abbreviation DNS) by which clients and origins are assigned a particular, unique address, known as an IP address. IP addressing can include all types of IP addressing protocols such as IPv4 and IPv6. Wireless routers use media access control (herein abbreviated MAC) addressing to uniquely identify wireless devices coupled with it. NetBIOS over TCP/IP represents another protocol which includes an addressing system for uniquely identifying clients and origins in the Internet. A further group of unique identifier addressing protocols includes different types of entity identification (herein abbreviated EID) addressing, such as locator/identifier separation protocol (herein abbreviated LISP). When a data request is made by a client, a determination must be made as to the network identifier of the origin, such that the data request can be forwarded to the origin and that when the data request is handled, the origin knows the network identifier to which it is supposed to send the requested data to. This process is known in the art as network identifier resolving or resolution and substantially represents the process by which the network identifier of the origin is determined by the client and the origin is made aware of the network identifier of the client. As mentioned above, network identifiers can be the IP address, MAC address, NetBIOS address, DNS, EID or any other identifier for uniquely identifying the location of a node (either client or origin) in a WAN such as the Internet. According to the prior art (not shown in FIG. 4B), when client 106₁₃ makes its data request from origin 104₄ it may perform a process of DNS resolving to know where in the Internet is it supposed to send its request. Likewise, origin 104₄ may be made known of the IP address of client 106₁₃ in order to know where it is to transfer the requested data to.

In FIG. 4B, the WAN optimization system of the disclosed technique, which includes server nodes 102A-102E, is referred to by an arrow 140. According to the disclosed technique, a best request node in WAN optimization system 140 for client 106₁₃ is determined. The best request node may represent the closest server node in WAN optimization system 140 to client 106₁₃. The best request node may also represent the server node in WAN optimization system 140 having the quickest response time with client 106₁₃, and not necessarily being the closest server node to client 106₁₃. For example server node 102E may be the closest server node to client 106₁₃, however server node 102E may be loaded with many requests and may thus be slow to respond to a request from client 106₁₃. Server node 102D, which may be farther than server node 102E is to client 106₁₃, may be less loaded with requests and may be able to serve client 106₁₃ quicker. Thus server node 102D may be selected as the best request node for client 106₁₃. The best request node may be determined by a variety of known heuristics. For example, if the disclosed technique is embodied as a piece of software, then when the user at client 106₁₃ initially starts the software, according to the disclosed technique, a heuristic, such as a shortest path algorithm, is used to determine the closest server node in WAN optimization system 140 to client 106₁₃. In this embodiment, a user is required to install a piece of software on their client to use the disclosed technique and to thus configure their client. Once the best request node has been determined for a client, any data requests from the client are then forwarded to the best server node which serves as its request node. Another heuristic may be to send a ping request from client 106₁₃ to various server nodes in WAN optimization system 140 to determine which server node responds the quickest. Thus the quickest responding server node may be selected as the best request node for client 106₁₃. According to another embodiment of the disclosed technique, the best request node for client 106₁₃ may be periodically updated by determining if the closest server node to it is also the quickest to respond to it. If yes, then the closest server node may serve as the request node for client 106₁₃. If no, then the quickest server node to respond to it may server as the request node for client 106₁₃. Other criteria may be used to periodically update the request node for a particular client.

The disclosed technique may also be embodied without software having to be installed on the client. In this embodiment, a non-device configuration is used to forward data request to WAN optimization system 140, which then determines which server node should serve as the request node for a particular client. Examples of this embodiment are given as follows. In one example, a client may access a SOCKS file proxy (not shown) which forms a part of WAN optimization system 140. The SOCKS file proxy determines which server node is best for the client as a request node in the WAN optimization system of the disclosed technique. Subsequent data requests from the client will then be forwarded via the SOCKS file proxy to the determined best request node. In a further example, a user may change the DNS server in their web browser or in an application in the client device capable of accessing the Internet, a WAN, a LAN or an intranet, to a DNS server provided by WAN optimization system 140. The DNS server of the WAN optimization system will then determine which server node is the best request node for the client, using known heuristics, as described above. In this manner, all data requests from the client are forwarded to the determined best request node. The DNS server of the WAN optimization system may periodically use known heuristics to verify if the current best request node for a given client is indeed the best request node for the client; and if not, the DNS server may change the assigned best request node for a given client to another request node. An additional example includes using the border gateway protocol (herein abbreviated BGP) to forward requests of a client to WAN optimization system 140 which then determines an appropriate request node for a given client.

As shown in FIG. 4B, server node 102E is determined to be the best request node for client 106₁₃. The data request of client 106₁₃ is thus forwarded to server node 102E, which will now be referred to as request node 102E. This is shown by an arrow 132. As mentioned above, each server node (either a request node or an origin node) may include a DDS for storing data values related to data requests it has handled and for storing information about the topology of WAN optimization system 140. When request node 102E receives the data request from client 106₁₃, it then performs a process of network identifier resolving to determine the location of the origin which stores the requested data. As mentioned above, network identifier resolving may be DNS resolving, MAC resolving, IP resolving, NetBIOS resolving or other address resolving to determine the location of the origin in the WAN which stores the requested data. It is noted that at least one process of network identifier resolving may be performed by the request node. Once the origin has been found, request node 102E then determines which server node in WAN optimization system 140, including itself, it best for retrieving the data requested by client 106₁₃, i.e., what is the best origin node. As mentioned above, in one embodiment, the best origin node may be the server node closest to the origin where the requested data is located. This can be determined using various known heuristics. The best origin node may also be the server node closest to a proxy server coupled with the origin, which has a local copy of the requested data. Once the request node has determined the best origin node (i.e. which server node is best for retrieving the requested data), the request node sends the data transfer request to the origin node. As shown in FIG. 4B, since origin 104₄ is located in the US, request node 102E determined that server node 102B is the best server node for retrieving the requested data from origin 104₄. Server node 102B will now be referred to as origin node 102B. Request node 102E then sends the data request to origin node 102B. This is shown by an arrow 134.

Origin node 102B receives the data request and retrieves the requested data from origin 104₄. Since origin node 102B is physically significantly closer to origin 104₄ (both are located in the US), the data rate at which it can retrieve the requested data is significantly faster than the data rate at which request node 102E or client 106₁₃ could retrieve the data, both of which are physically located in Israel. This is shown in FIG. 4B by an arrow 136. Once origin node 102B retrieves the requested data, it transfers the requested data back to request node 102E. Request node 102E then transfers the requested data back to client 106₁₃. As shown in FIG. 4B, straight line arrows, such as arrows 132, 134 and 136, are double-headed, reflecting the bidirectional nature of data that flows between, i.e., to and from, server nodes (request nodes and origin nodes), origins and clients. It is noted that the data rate between origin node 102B and request node 102E is significantly higher than the data rate between origin node 102B and client 106₁₃. As mentioned above, all the server nodes in WAN optimization system 140 include WAN optimization hardware, software or both. Therefore, the data requested by client 106₁₃ is transferred most of the path from origin 104₄ to client 106₁₃ using WAN optimization techniques, thereby transferring the requested data back to client 106₁₃ at a substantially higher data transfer rate as compared to the prior art. In the data path shown in FIG. 4B from origin 104₄ to client 106₁₃ (i.e., arrows 136, 134 and 132), a significant portion of the data path transfers data at a substantially high data rate using WAN optimization techniques. The smaller portions of the data paths, namely the data paths from origin 104₄ to origin node 102B and from request node 102E to client 106₁₃, transfer data at a slower rate which is dependent on a number of factors as listed above in the background section, such as the time of day the data request is made, the type of subscriber client 106₁₃ is, business arrangements between various ISPs located between client 106₁₃ and request node 102E and the like. However, both request node 102E and origin node 102B were selected as the ‘best’ server nodes such that data transfers from client 106₁₃ and request node 102E are as fast as possible and data transfers from origin 104₄ and origin node 102B are as fast as possible. Thus the overall data transfer rate between client 106₁₃ and origin 104₄ is maximized according to the disclosed technique.

After request node 102E transfers the requested data to client 106₁₃, request node 102E updates its DDS. The entry in its DDS may list the IP address of client 106₁₃ which made the data request as well as which origin node handled the request (in this example, origin node 102B) and where the origin is located. Depending on the data requested, the DDS may also include an entry having values that represent the data transferred. As explained below (and also in FIG. 4C below), if another client requests the same data as previously requested by client 106₁₃, then this entry in the DDS of origin node 102E can be used to further increase the data transfer rate of retrieving the requested data and providing it to the other client which requested the data.

Another example of an increased data transfer rate according to the disclosed technique is shown in FIG. 4B. In this example, client 106₁₃ makes a data request from origin 104₄, where origin 104₄ is a news website having a CDN, with proxy servers all over the world. In FIG. 4B, origin 104₆ is a proxy server of origin 104₄ and maintains local copies of data stored in origin 104₄. As mentioned above, a CDN reduces the amount of data requests made directly to origin 104₄ and also enables clients which are physically far from origin 104₄ and closer to origin 104₆ to receive data transfers from the news website quicker by accessing an origin which is physically closer to them, thus resulting in an increased data transfer rate. Origins 104₄ and 104₆ may communicate with one another using WAN optimization hardware, software or both depending on how the CDN is set up. As shown, the data request of client 106₁₃ from origin 104₄ is forwarded to request node 102E. Request node 102E performs network identifier resolving and determines that the best origin node for handling the request is origin node 102B. Request node 102E forwards the data transfer request to origin node 102B. Origin node 102B then sends a request to retrieve the requested data from origin 104₄. The request of origin node 102B may include an indication that the original request for data originated from another part of the world (i.e., not from where origin node 102B is physically located), such as the region where request node 102E is located or where client 106₁₃ is located. Origin 104₄ may then respond to origin node 102B with a message stating that it has a proxy server, origin 104₆, which is physically closer to request node 102E than origin 104₄ and that the request should be handled by origin 104₆. Using the data structure in origin node 102B which stores information about the topology of the WAN optimization system and network of the disclosed technique, origin node 102B then performs network identifier resolving of the location of origin 104₆ and determines that server node 102C is the best origin node for retrieving the requested data from origin 104₆. Origin node 102B then sends a message to request node 102E to forward the data request of client 106₁₃ to server node 102C, which will serve as the best origin node for handling the data request of client 106₁₃. Request node 102E then forwards the data request of client 106₁₃ to origin node 102C, shown by a dot-dash line 142. Origin node 102C then retrieves the requested data from origin 104₆, shown by a dot-dash line 144, and transfers it back to request node 102E, which transfers it to client 106₁₃. Client 106₁₃ thus receives the requested data at an increased data transfer rate since data transfer rates between request node 102E and origin node 102C are performed using WAN optimization techniques. In addition, origin node 102C and request node 102E are physically closer to one another in comparison to origin node 102B and request node 102E, thus further increasing the data transfer rate.

A further example of an increased data transfer rate according to the disclosed technique is shown in FIG. 4B. As shown, another client, such as client 106₁₂, may make a similar request for the data requested by client 106₁₃. The data may be something current and popular which a plurality of users may want to view, such as a movie, a recent news story report by video or a new song released by a popular artist. The data request of client 106₁₂ occurs after the data request of client 106₁₃. When a data request is made and data is transferred, the data transferred includes metadata about the actual data transferred. One of the tags in the metadata relates to whether the data transferred can be cached (i.e., stored locally) and if yes, for how long (i.e., in how much time will the data expire). Data which can be cached usually has a metadata tag with the entry ‘cached enabled’ as well as a TTL (time to live) tag listing how long the data may remain cached before the data must be retrieved again from the origin. Data which was cached enabled but has been cached for longer than its TTL is referred to as being expired. If the data requested by client 106₁₃ was cached enabled and has not yet expired when 106₁₂ makes a request for the same data, then the DDS of request node 102E may include an entry about the data requested from origin 104₄. Assuming that it has already been determined that the best request node for client 106₁₂ is server node 102E, client 106₁₂ sends a data request for data from origin 104₄ to request node 102E. This is shown by an arrow 138. Server node 102E receives the request and forwards it to origin node 102B, which retrieves the requested data from origin 104₄. As origin node 102B begins to compress the requested data, it may notice that the data is already contained in its DDS and will then send a message to request node 102E to reconstruct the data for client 106₁₂, from its own DDS. According to another embodiment of the disclosed technique, request node 102E may checks its DDS once it receives a data request from a client to determine if the requested data has been requested before by another client. Request node 102E determines that another client, client 106₁₃, has already requested the data and has received it from origin 104₄. Thus, request node 102E can reconstruct the requested data from its DDS and forward it to client 106₁₂.

According to this embodiment of the disclosed technique, using its DDS, request node 102E can reconstruct the data which it previously retrieved from origin node 102B and transfer it to client 106₁₂, thereby obviating the need to even transfer the data request to origin node 102B. In this embodiment, the entry in the DDS of request node 102E corresponding to the requested data by client 106₁₂ is sufficient to reproduce the requested data. Request node 102E can thereby provide client 106₁₂ with the requested data at a significantly increased data transfer rate, since no data needs to be retrieved from origin node 102B or origin 104₄. However, it should be noted that in this example it is assumed that the requested data requested by clients 106₁₃ and 106₁₂ are exactly the same and that nothing has changed in the requested data between the time when client 106₁₃ requests the data and the time when client 106₁₂ requests the data. As mentioned above, it is also assumed that the requested data was cached enabled and has not yet expired.

Studies have shown that any two websites accessible on the Internet, even in two completely different languages with very different content, such as a news website in Chinese and a cooking website in French, share a significant amount of similarities in their HTML coding. Websites, in their HTML coding, are comprised of tags, metadata, field codes and content. A significant portion of any website is comprised of the tags, metadata and field codes which are used in the HTML coding of the website; the actual unique content on a website may account for a significantly small portion of the data contained within the HTML coding of the website. Thus the Chinese news website and the French cooking website may only differ in their content while sharing substantially similar tags, metadata and field codes. The similarities in HTML coding between any two websites may be as high as 95%. The differences in HTML coding of two websites can be referred to as the delta between the websites. The delta can also be defined in terms of a single website with dynamic content that is constantly changing. Dynamic content may be as simple as the time or date listed on a website or may be changing images or videos, such as on a news website.

With reference back to the previous example, both of clients 106₁₃ and 106₁₂ may request data from origin 104₄, however the data requested may be different. For example, if origin 104₄ is a news website, clients 106₁₃ and 106₁₂ may have requested to view the images and text associate with two different news stories displayed on the news website. As another example, clients 106₁₃ and 106₁₂ may have requested to view the same news stories except at different times during the day, when dynamic content other than the news story may have changed, such as the time and date displayed on the news website, i.e., any cached data on request node 102E may have expired. According to the disclosed technique, assuming client 106₁₃ already requested data from origin 104₄, and received it, as described above, client 106₁₂ may then also request data from origin 104₄. Recall that request node 102E and origin node 102B have both updated their DDSs and may include entries and values which relate to the data request transferred to client 106₁₃ if the data transferred was cached enabled. Client 106₁₂ forwards its data request to request node 102E, which forwards the data request to origin node 102B. Origin node 102B then retrieves the requested data from origin 104₄. As origin node 102B begins to compress and encode the retrieved data to forward it to request node 102E, it may determine that a significant portion of the requested data already exists in its DDS. Origin node 102B may examine the retrieved data and may determine the delta between the data requested by client 106₁₃ and client 106₁₂. The delta can be determined based on the entries in the DDS of origin node 102B. Origin node 102B forwards the delta in the retrieved data to request node 102E along with a message stating that the rest of the data request can be reconstructed from the DDS of request node 102E. Based on the entries in the DDS of request node 102E from when client 106₁₃ requested data from origin 104₄ and on the data retrieved by origin node 102B, request node 102E reconstructs the data requested by client 106₁₂ and forwards it to client 106₁₂. In this respect, the data transfer rate for client 106₁₂ is significantly increased as a majority of the data requested was forwarded to client 106₁₂ directly from request node 102E, which is physically close to client 106₁₂, without having to retrieve it from origin 104₄ or from origin node 102B. In addition, the data transferred from origin node 102B (i.e. the delta in the data request) to request node 102E amounted to a minority of the data requested by client 106₁₂, which was nonetheless transferred to request node 102E using known WAN optimization techniques.

As mentioned above, data can be transferred between server nodes of WAN optimization system 140 using any known WAN optimization technique. One such technique is known as pre-fetching and can be implemented in a request node or an origin node according to the disclosed technique. According to the prior art, when a client requests data from an origin, since web browsers are designed using interpreted computer programming languages, multiple data requests are actually sent to the origin by the client to fully retrieve the requested data. For example, to see the website of a news station, such as the homepage of CNN.com, a client may have to make 50-100 data requests until the entire homepage of CNN.com is loaded. This limitation in terms of having to make multiple data requests just to retrieve the data of a single website may also be built-in as part of the limitations of a web browser. According to one embodiment of the disclosed technique, as mentioned above, each data request from a client is forwarded to a best request node, which forwards it to a best origin node which retrieves the data from the origin. The retrieved data is transferred back to the origin node which transfers it to the request node and eventually back to the client. Therefore, in this embodiment, a request node may need to forward 50-100 data requests on behalf of the client to the origin node.

According to another embodiment of the disclosed technique, the request node or the origin node may use a technique of pre-fetching to increase the data transfer rate for the data request of the client. In this embodiment, when the request node initially receives a first data request from a client and performs network identifier resolving, it can determine all the data requests that the client will have to perform to receive the data it requested. For example, the request node may be able to determine all the data requests necessary in order to display all the information on the homepage of CNN.com. In this embodiment, instead of the request node waiting for the client to forward it the next data request in order to fully retrieve the data requested, the request node pre-fetches the data to be requested by the client by forwarding all the data requests the client will make for the requested data to the origin node. For example, the request node may forward all 50-100 data requests at once to the origin node, which will retrieve all the requested data from the origin, transfer it back to the origin node which will transfer the requested data back to the request node. It is noted that web browsers on clients are limited in terms of how many simultaneous data requests they can make when loading a webpage to prevent the client from crashing or from running out of RAM. In the disclosed technique, since a server node (either a request node or an origin node), which is not a web browser, performs the pre-fetching, it is not limited to what a web browser on a client is capable of and can thus forward all the data requests necessary for loading a webpage at once. When the client sends an additional request for data for a given data request, the data will already be at the request node which can simply transfer the requested data to the client. By having the request node pre-fetch the data the client will be requesting from the origin, the data transfer rate for a regular Internet user can be significantly increased. It is noted that the above description related to the request node performing the technique of pre-fetching. It is noted that according to the disclosed technique, pre-fetching can also be performed by the origin node instead of the request node. In this embodiment, the origin node may pre-fetch requested data from the origin by sending the origin requests for all the data which will fulfill the data request of the client. When each data request from the request node is received by the origin node, the origin node can immediately forward the retrieved data to the request node without having to first retrieve it from the origin. It is noted that pre-fetching is only possible if the data requested from the origin is cache enabled and has not yet expired when the client requests data that was already pre-fetched. It is also noted that according to the disclosed technique, pre-fetching can be performed by the request node or the origin node. Heuristics can be used to determine if pre-fetching by the request node or the origin node is faster in terms of transferring the data to the client. Whichever server node is faster will be the one used to pre-fetch the requested data.

Reference is now made to FIG. 4C, which is a schematic illustration of the WAN optimization system and network of FIG. 4A, showing a data transfer between two nodes using clustering, generally referenced 160, constructed and operative in accordance with a further embodiment of the disclosed technique. Similar elements in FIGS. 4B and 4C are labeled using identical numbering. FIG. 4C shows a client 106₇ making a data request for data from origin 104₄. As mentioned above, a best request node for client 106₇ is determined. As shown, the best request node for client 106₇ is server node 102C, herein referred to as request node 102C. Client 106₇ requests similar data to the data that clients 106₁₂ and 106₁₃ requested, as was described above in FIG. 4B. For example, client 106₇ requests to view a news story from origin 104₄, or requests to view the same news story that both clients 106₁₂ and 106₁₃ requested to view except at a different time such that dynamic content on origin 104₄ may have changed. Client 106₇ sends its data request to request node 102C, as shown by an arrow 162. According to the disclosed technique, request node 102C performs network identifier resolving to determine which server node in WAN optimization system 140 is closest to the source of the requested data, to origin 104₄. Request node 102C determines that the best server node, i.e. the best origin node, for retrieving the requested data is server node 102B, herein referred to as origin node 102B. According to the embodiment of the disclosed technique as described in FIG. 4B, request node 102C sends the data request to origin node 102B, shown by a dashed arrow 164. Origin node 102B would then retrieve the requested data from origin 104₄, shown by a dashed arrow 166. The retrieved data would then be sent back to request node 102C, which would provide it to client 106₇. According to one embodiment of the disclosed technique, if request node 102C has already handled a data request similar to the data request of client 106₇, then when origin node 102B is preparing the retrieved data from origin 104₄ to be sent to request node 102C, origin node 102B may notice from its DDS that a portion of the data may be able to be reconstructed from the DDS of request node 102C. In such a scenario, origin node 102B will send a message to request node 102C, indicating that it can reconstruct a portion of the data from its DDS. The portion of the data missing from the DDS of request node 102C will be forwarded to it by origin node 102B. In this respect, request node 102C will provide the requested data to client 106₇ from the data received from origin node 102B as well as data it can reconstruct from its own DDS.

FIG. 4C shows how server nodes which are part of WAN optimization system 140 can be clustered to further improve data transfer rates for regular Internet users. As shown, server nodes 102C and 102E form a cluster, depicted by an ellipse 168. The membership of which server nodes in WAN optimization system 140 are part of which clusters may be stored in the DDS of each of server nodes 102A-102E. When client 106₇ requests data from origin 104₄, request node 102C sends the data request to origin node 102B. Origin node 102B retrieves the requested data from origin 104₄. As origin node 102B begins to prepare the retrieved data to be transferred back to request node 102C, origin node 102B may determine the delta in the data request between the requested data from request node 102C and any other server node (or request node) which is in the same cluster as request node 102C. Assuming the data request of client 106₇ in FIG. 4C occurred after the data request of clients 106₁₂ and 106₁₃ in FIG. 4B, when origin node 102B begins to prepare the transmission of the retrieved data from origin 104₄, it checks its DDS to determine the delta in the requested data between the data request of request node 102C and request node 102E, which are both in the same cluster, as depicted by ellipse 168. If request node 102E has transmitted a similar data request to origin node 102B, then a relatively small delta may exist between the data requested by request node 102C and the data previously requested by request node 102E. Origin node 102B then determines that request node 102E has provided it with a similar data request, and origin node 102B then determines the delta between the data request of request node 102C, request node 102E and the data request of client 106₇ from origin 104₄. Origin node 102B can then transmits a message to request node 102C informing it that it may be able to reconstruct a portion of the requested data of client 106₇ from entries in its DDS and from the DDS of request node 102E. In such an embodiment, origin node 102B transmits the portion of the retrieved data which request node 102C cannot reconstruct from its DDS to request node 102C. In addition, request node 102C sends the delta in the requested data from client 106₇ to request node 102E, as shown by an arrow 170. Request node 102E then transfers the entries from its DDS which are relevant to the data request of request node 102C to request node 102C, which can then reconstruct the data requested by client 106₇. Request node 102C can thus transfer the requested data of client 106₇ by merely retrieving information and entries in the DDSs of the server nodes in the cluster in which it is a member, while only having to retrieve the portion of the data request of client 106₇ from origin 104₄ which it could not reconstruct from the DDSs of any of the request nodes in the cluster which it is a member of. As described above, if a delta exists between the data which can be reconstructed from the DDSs in the cluster depicted by ellipse 168 and the data requested by client 106₇, then origin node 102B may send a message to request node 102C to reconstruct the requested data of client 106₇ from the DDSs of the server nodes in its cluster and that any delta which still exists after that will be completed by origin node 102B transferring the remaining delta in the data request it already retrieved from origin 104₄. Origin node 102B then transfers that delta to request node 102C which can then reconstruct and forward the requested data back to client 106₇.

In the embodiment as shown in FIG. 4C, each server node includes a DDS, whereby resources amongst server nodes in a cluster can be shared. Request node 102E has information stored in its DDS about the data it previously requested from origin 104₄ which client 106₇ is now requesting. As mentioned above, request node 102E can transfer information in its DDS about the requested data to request node 102C. Using its own DDS and the information provided by the DDS of request node 102E, request node 102C can reconstruct data requested by client 106₇. Request node 102C thus reconstructs the requested data and then provides it client 106₇. Also as mentioned above, origin node 102B may also need to provide a portion of the data requested to request node 102C before request node 102C can reconstruct the data requested by client 106₇. Client 106₇ thus receives the requested data at an increased data rate as request nodes 102E and 102C transfer data between themselves using WAN optimization techniques. In addition, request node 102E does not need to retrieve the requested data from another location, such as from an origin, thus reducing the length of the data path from the location where data can be reconstructed (request nodes 102E and 102C) to the location which requested the data (client 106₇), thereby also increasing the data transfer rate.

It is important to note that unlike the prior art, the disclosed technique, such as WAN optimization system 140, does not require more than one DDS per server node. As its name suggests, the distributed aspect of the DDS of a server node enables each server node to store information about data requests that it handles and about the topology of the WAN optimization system. The DDS of each server node does not store a local copy of data requested by a particular client. The information stored in the DDS can be used by the server node to reconstruct a future data request for the same, or similar data if the data handled can be cached and has not yet expired. In addition, the information stored may be used by the DDS of another server node to reconstruct other data requests. By distributing the information stored about data requests, each server node only needs to keep track of its own DDS, however via clustering, a server node can access the DDS of another server node in its cluster to reconstruct a data request it never previously handled.

It is noted that server nodes 102E and 102C may be part of the same cluster since they are physically closer to one another in comparison to other server nodes in WAN optimization system 140. According to the disclosed technique, clusters may be formed at various levels of resolution. For example, clusters may be formed of server nodes located in the same country, server nodes located in the same continent or server nodes located in the same landmass (as shown in FIG. 4C). Clusters may also be formed at the level of clients which couple with the WAN optimization system of the disclosed technique, provided such clients give permission to a server node to retrieve data the clients have previously requested, received and stored locally. For example, clusters may be formed with clients living in the same city, the same neighborhood or even living on the same street. Clustering may also occur in an enterprise setting, such as in a company or in a location, such as a hotel, where many clients may be accessing similar type entertainment websites. For example, clients which are coupled with a LAN or an intranet in a company may form a cluster according to the disclosed technique if the data requests of the clients in the LAN or intranet are similar. In such a scenario, one of the clients may be designated as a server node which forms part of the WAN optimization system of the disclosed technique. Any data requests of clients within the LAN may be forwarded to the client designated as the server node, which would then forward the data request to an origin node as described above.

It is noted that according to the disclosed technique, the determination of a request node and an origin node can be executed recursively. As mentioned above, a data request is forwarded from a client to a request node, which then forwards the data request to an origin node which finally requests the data from an origin. Both the request node and the origin node may in turn search out other request nodes and origin nodes which may be better for handling the data request of the client. Using the example mentioned above regarding a LAN, a client in a LAN which is designated as a server node may forward a received data request to an origin node (from its perspective). The origin node receiving the data request may then be designated a request node and will then determine what is the best origin node (from its perspective). This process can go on recursively between various request node-origin node pairs in the WAN optimization system of the disclosed technique until the data request is forwarded to the origin.

In general, clustering reduces the number of requests placed on an origin. As mentioned above, according to the disclosed technique, the number of routers via which data is transferred from a server node, whether a request node or an origin node, to a client is decreased. This is achieved by using clustering, thus increasing the data transfer rates between nodes by reducing the number of nodes needed to transfer data from a server node to a client. According to the disclosed technique, instead of clients constantly requesting data directly from an origin, such as origin 104₄, the data requests can be sent to other locations in WAN optimization system 140 which receive fewer requests for data. The data rate at which an origin can retrieve and transfer data is proportional to the number of data requests the origin receives. Thus, server nodes which have in their DDSs entries from which requested data can be reconstructed can transfer the data quicker as opposed to an origin having the original copy of the requested data. The server nodes may also be located physically closer to the client which requested the data than the origin which has the original copy of the requested data. This reduces the data path length of the source location of the data, the origin, to the destination location which requested the data, the client, further increasing the data transfer rate. However, if a particular server node receives too many requests for a given piece of data, then the data transfer rate from that server node may be comparable to the data rate of retrieving the requested data from the origin having the original copy of the requested data. According to the disclosed technique, such a server node may be removed from the cluster it is currently a part of as it is receiving too much Internet traffic and is slowing down the overall data transfer rate in the WAN optimization system of the disclosed technique. In addition, a server node receiving very little Internet traffic may be made part of a cluster in order to take advantage of the data transfer rate at which it can retrieve and send data. In this respect, according to the disclosed technique, network analytics are used to monitor the flow of data through server nodes in the WAN optimization system of the disclosed technique. Depending on the determined flow of data through a server node, according to the disclosed technique, a server node may be added or removed from a cluster in order to increase the overall data transfer rate of the WAN optimization system of the disclosed technique. Decentralized management techniques may be used to add or remove server nodes from clusters. For example, server nodes may periodically perform self-assessment tests to determine how loaded they are with Internet traffic and thus determine if they should remove themselves from a cluster or join a cluster.

According to the disclosed technique, clients which can forward data requests to request nodes in the WAN optimization system can themselves form part of the WAN optimization system of the disclosed technique. In this respect, any client can be a request node or an origin node for another client. In general, such a scenario will apply when a plurality of clients form a cluster together. A data request from a client in the cluster may be forwarded to another client in the cluster acting as a request node. This client would then forward the data request to an origin node, which may in turn designate itself a request node and then forward the data request to another origin node. As mentioned above, this recursion may be used a plurality of times among server nodes in the WAN optimization system of the disclosed technique until the data request from the client reaches the origin, with data requests between the client and the origin being forwarded between request node and origin node pairs.

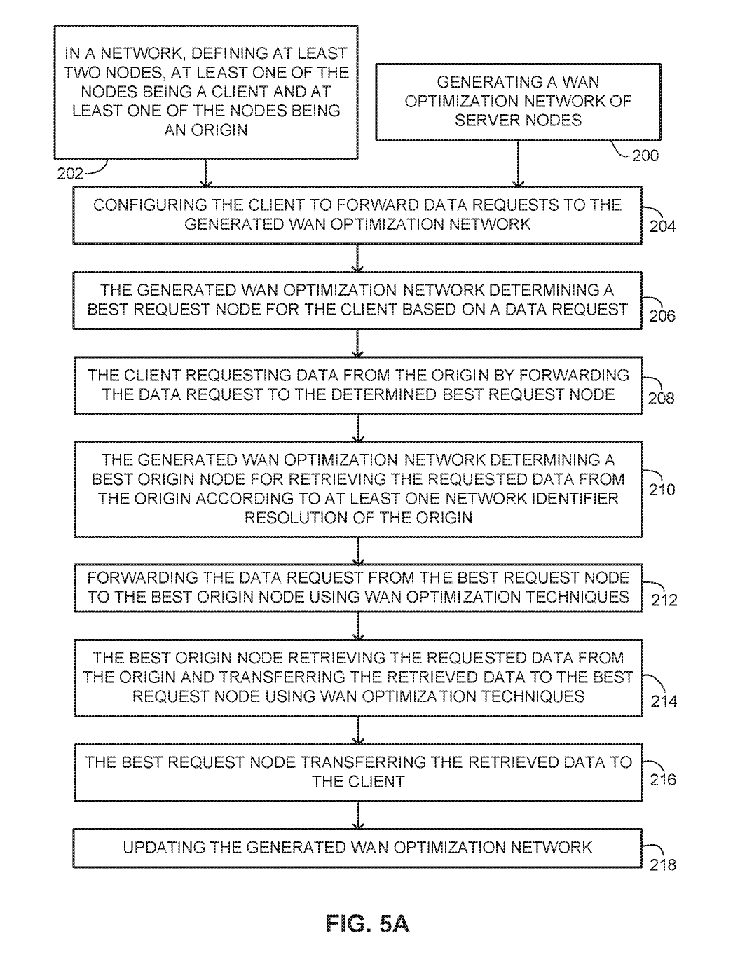

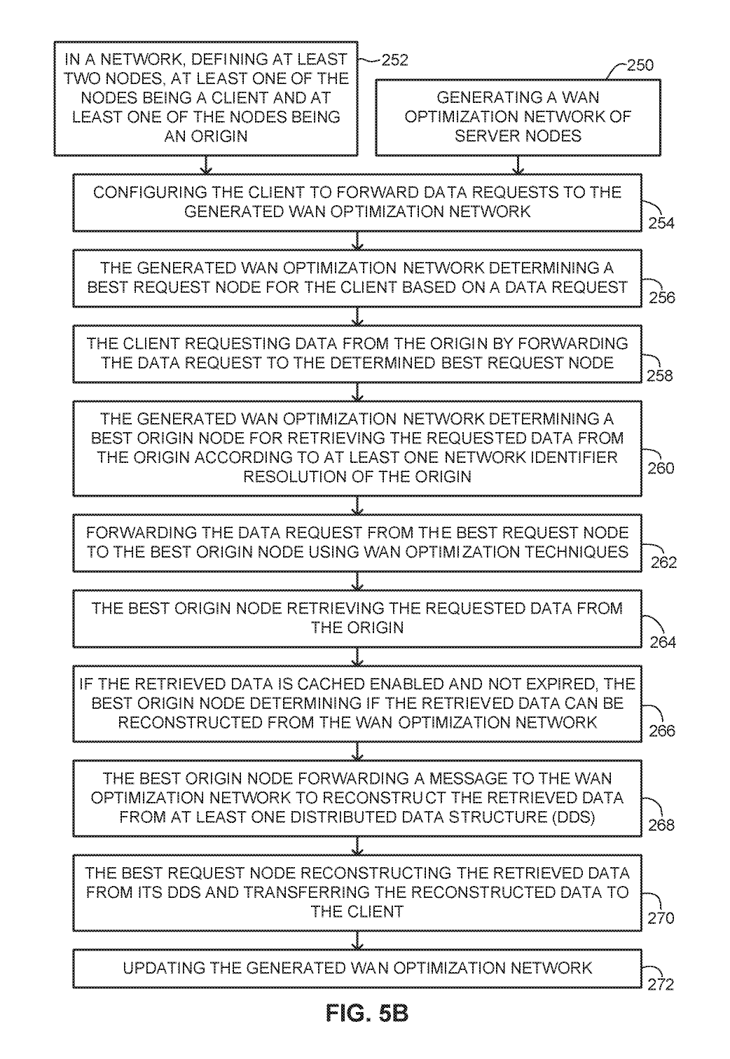

Reference is now made to FIG. 5A, which is a schematic illustration of a first WAN optimization method, operative in accordance with another embodiment of the disclosed technique. In a procedure 200, a WAN optimization network of server nodes is generated. It is noted that each server node may maintain an updated DDS, including data requests that it has served and handled as well as the topology of the WAN optimization network. The WAN optimization network includes at least two server nodes, which may be located in different parts of the world. Server nodes in the WAN optimization network can communicate with one another using WAN optimization techniques. For example, each server node may be equipped with WAN optimization hardware, WAN optimization software or both. With reference to FIG. 4A, WAN optimization system 100 includes a wide area network including a plurality of server nodes 102A, 102B, 102C, 102D and 102E. Each one of server nodes 102A-102E is located in physically different locations throughout the world. Each server node may include a single DDS (not shown). Server nodes 102A-102E may each include known WAN optimization hardware (not shown), WAN optimization software (not shown) or both. As such, server nodes 102A-102E can transfer data between themselves at a significantly high data transfer rate.

In a procedure 202, at least two nodes in a network, such as the Internet, are defined. At least one of the nodes is designated as a client and at least one of the nodes is designated as an origin. The client may be a user node requesting data or services from a website, a reverse proxy or a server node. The client may also be a server node requesting information from another server node. The origin may be the source of where the requested data is located, such as a website or reverse proxy. The origin may also be a server node which can reconstruct the requested data and transfer it to the client if the requested data can enabled to be cached on the server node. With reference to FIG. 4B, client 106₁₃ makes a data transfer request of origin 104₄. With reference to FIG. 4C, server node 102C then determines that server node 102E has already retrieved the requested data, and sends the request for data from client 106₇ to server node 102E, as shown by an arrow 170. In this example, server node 102C represents a client and server node 102E represents an origin. As shown, procedures 200 and 202 can occur simultaneously.

In a procedure 204, the client is configured to forward its data requests to the generated WAN optimization network of procedure 200. The client may be configured via device configuration or via non-device configuration. In device configuration, an application running on the client capable of accessing the Internet, a WAN, a LAN or an intranet, is specifically configured to forward data requests of the client to the generated WAN optimization network. The application may be a web browser running on the client, for example. The application may be configured by a piece of software installed on the client to forward data requests to the generated WAN optimization network. In non-device configuration, various protocols may be used by the client to forward data requests to the generated WAN optimization network, such as DNS and BGP. An example of such a configuration is by changing the DNS settings of an application on the client to forward data requests to a DNS server which forms part of the WAN optimization network. The DNS server then forwards data requests of the client to the best request node for the client in the WAN optimization network. BGP can also be used with the disclosed technique for forwarding the data request of the client to the WAN optimization network which then decides on the best request node for the client. With reference to FIG. 4B, in one example, a client may access a SOCKS file proxy (not shown) which forms a part of WAN optimization system 140. The SOCKS file proxy determines which server node is best for the client as a request node in the WAN optimization system of the disclosed technique. In a further example, a user may change the DNS server in their web browser or in an application in the client device capable of accessing the Internet, a WAN, a LAN or an intranet to a DNS server provided by WAN optimization system 140. The DNS server of the WAN optimization system will then determine which server node is the best request node for the client, using known heuristics, as described above. An additional example includes using the border gateway protocol (herein abbreviated BGP) to forward requests of a client to WAN optimization system 140 which then determines an appropriate request node for a given client.

In a procedure 206, a best request node for the client in the generated WAN optimization network is determined based on a data request. The best request node for the client can be determined according to various known heuristics. For example, the best request node may be the server node in the WAN optimization network which is physically closest to the client or the server node having the quickest response time in communicating with the client. The determined best request node for a client may change with time and is based on a current data request. It is noted that the best request node is a server node within the WAN optimization network generated in procedure 200. As mentioned above in FIG. 4C, a client which forms part of a cluster can be considered a server node which forms part of the generated WAN optimization network. As such, a client in a cluster may be determined to be the best request node for another client in the cluster. With reference to FIG. 4B, the best request node may represent the closest server node in WAN optimization system 140 to client 106₁₃. The best request node may also represent the server node in WAN optimization system 140 having the quickest response time, and not necessarily being the closest server node to client 106₁₃.

In a procedure 208, a data request is sent from the client to the origin by forwarding the data request to the determined best request node in the WAN optimization network of procedure 204. Due to procedure 204, data requests from the client are forwarded to the generated WAN optimization network of procedure 200. The data request may be for a service from the origin or for data, such as a news story, a blog post or a video from the origin node. With reference to FIG. 4B, client 106₁₃ makes a data transfer request of origin 104₄. Once the best server node (i.e., the best request node) has been determined for a client, any data requests from the client are then forwarded to the best request node. As shown in FIG. 4B, server node 102E is determined to be the best request node for client 106₁₃. The data request of client 106₁₃ is thus forwarded to request node 102E. This is shown by an arrow 132.

In a procedure 210, a best origin node for retrieving the requested data from the origin is determined by the generated WAN optimization network according to the network identifier resolution of the origin. The best origin node represents the server node which can most efficiently retrieve the requested data from the origin and transfer it back in the direction of the best request node. For example, the best origin node may be a server node which is physically closest to the origin node. The best origin node may also be the same as the best request node. It is noted that the best origin node is a server node within the WAN optimization network generated in procedure 200. As mentioned above, a client in a cluster may form a part of the WAN optimization network and as such may be determined as a best origin node. With reference to FIG. 4B, server node 102E then determines which server node in WAN optimization system 140, including itself, is best for retrieving the data requested by client 106₁₃. As mentioned above, in one embodiment, the best origin node may be the server node closest to the origin where the requested data is located. This can be determined using various known heuristics.

The network identifier resolution of the origin is used to determine the best origin node by determining where the client is located in the network, where the origin is located in the network and whether any server nodes in between the client and the origin have already retrieved the requested data. For example, as mentioned above, each server node in the generated WAN optimization network of procedure 200 may maintain an updated DDS of data requests it has served and handled. The DDS may store the data previously requested. As mentioned above, if a best request node or a neighboring request node has already retrieved the requested data by the client, it may be possible, via the DDSs of those nodes, if the data was cached enabled, to reconstruct the retrieved data for the client. In these scenarios, the best origin node may not be physically near the origin at all!

It is noted that procedures 208 and 210 may be executed in a recursive manner by which a best request node for a client may determine a best request node for itself, which in turn may determine a best request node for itself and so on. Likewise, a best origin node as determined by a best request node may determine a best origin node for itself, which in turn may determine a best origin node for itself and so on. In this manner, a data request can be forwarded between request node-origin node pairs, with a client forwarding the original data request to a first request node and the last origin node forwarding the data request to the origin.

In a procedure 212, the request for data from the best request node is forwarded to the best origin node using WAN optimization techniques. As mentioned above, all the server nodes in the WAN optimization network of the disclosed technique can use WAN optimization techniques for transferring data between themselves. According to the disclosed technique, the request for data is forwarded using at least one WAN optimization technique. In addition, as mentioned above, the best origin node may be the best request node, for example in the case where the best request node already retrieved the data requested and was able to cache it. Using its DDS, the best request node may be able to reconstruct the data requested by the client and thus is simultaneously the best request node and the best origin node. With reference to FIG. 4B request node 102E then determines which server node in WAN optimization system 140, including itself, it best for retrieving the data requested by client 106₁₃. As mentioned above, in one embodiment, the best origin node may be the server node closest to the origin where the requested data is located. Once the request node, or the WAN optimization system, has determined which server node is best for retrieving the requested data, the request node sends the data transfer request to the best origin node.

In a procedure 214, the best origin node receives the request for data from the best request node and retrieves the requested data from the origin. The best origin node then transfers the retrieved data back to the best request node using WAN optimization techniques. According to the disclosed technique, at least one WAN optimization technique is used to transfer the retrieved data back to the best request node. As mentioned above, the best origin node always retrieves the requested data from the origin. Depending on the DDS of the best origin node and the DDS of any server nodes in its cluster, the best origin node may indicate to the best request node that is can reconstruct the requested data from its DDS without having to retrieve anything from the origin node. Furthermore, as mentioned above, depending on the DDS of the best request node and the DDS of any server nodes in its cluster, the best request node may be able to reconstruct the requested data from its DDS without having to receive any data from the best origin node. With reference to FIG. 4B, origin node 102B receives the data request and retrieves the requested data from origin 104₄. Once origin node 102B retrieves the requested data, it transfers the requested data back to request node 102E. Request node 102E then transfers the requested data back to client 106₁₃. As mentioned above, all the server nodes in WAN optimization system 140 include WAN optimization hardware, software or both. Therefore, the data requested by client 106₁₃ is transferred most of the path from origin 104₄ to client 106₁₃ using WAN optimization techniques, thereby transferring the requested data back to client 106₁₃ at a substantially higher data transfer rate over the prior art.

In a procedure 216, the best request node transfers the retrieved data to the client. As noted above, the best request node may be the origin node which reconstructed the requested data according to its DDS. With reference to FIG. 4B, once origin node 102B retrieves the requested data, it transfers the requested data back to request node 102E. Request node 102E then transfers the requested data back to client 106₁₃. In a procedure 218, the WAN optimization network is updated. This is based on the data request handled and which server nodes in the WAN optimization network played a role in handling the data request. Updating the WAN optimization network may include updating the DDSs of the best request node and the best origin node. It may also include updating the topology of the WAN optimization network as well as which server nodes are members of which clusters. As mentioned above, updating a DDS may include caching data if the requested data can be cached. With reference to FIG. 4B, after request node 102E transfers the requested data to client 106₁₃, request node 102E updates its DDS. The entry in its DDS will include information and a data entry related to the data request as well as the actual data transferred. As explained also in FIG. 4C, if another client requests the same data as previously requested by client 106₁₃, then the information and data entry in the DDS of request node 102E may be used to further increase the data transfer rate of retrieving the requested data and providing it to the other client which requested the data.

Reference is now made to FIG. 5B, which is a schematic illustration of a second WAN optimization method, operative in accordance with another embodiment of the disclosed technique. The method of FIG. 5B is similar to the method of FIG. 5A. As such, procedures 250 to 262 are respectively identical to procedures 200 to 212 and will not be described herein a second time. The method of FIG. 5B relates to a situation in which the retrieved data from an origin is cached enabled and has not yet expired. In such a scenario, the server nodes of the WAN optimization network may store local copies of the data requested or information related to the data from which the requested data can be reconstructed. After procedures 250 to 262, as described above, in a procedure 264, the best origin node retrieves the requested date from the origin. With reference to FIG. 4B, origin node 102B receives the data request and retrieves the requested data from origin 104₄. In a procedure 266, the best origin node determines if the retrieved data can be reconstructed from the WAN optimization network. This determining is based on the metadata of the retrieved data from the origin. If the retrieved data is cache enabled and has not yet expired, then the best origin node determines if the retrieved data was previously retrieved and handled. For example, as the best origin node compresses the retrieved data it may notice that it has already compressed the retrieved data, or data very similar to the retrieved data. The best origin node can thus determine if the best request node may have the retrieved data cached in its distributed data structure (DDS), or if another server node in the WAN optimization network has cached the retrieved data, such as another request node within the cluster that the best request node is a member of. With reference to FIG. 4B, server node 102E receives the request and forwards it to origin node 102B, which retrieves the requested data from origin 104₄. As origin node 102B begins to compress the requested data, it may notice that the data is already contained in its DDS and will then send a message to request node 102E to reconstruct the data for client 106₁₂, from its own DDS.

In a procedure 268, the best origin node forwards a message to the WAN optimization network of procedure 250 to reconstruct the retrieved data from at least one DDS. For example, the best request node may be able to reconstruct the retrieved data of the best origin node from its own DDS. The best request node may be able to reconstruct a portion of the retrieved data from its DDS while also accessing the DDS of another server node in the WAN optimization network, for example, the DDS of a server node in the same cluster. The best request node may further be able to reconstruct a portion of the retrieved data from its DDS while also receiving a portion of the retrieved data from the best origin node which it is not able to reconstruct from its DDS or the DDS of another server node. With reference to FIG. 4B, origin node 102B may examine the retrieved data and may determine the delta between the data requested by client 106₁₃ and client 106₁₂. The delta can be determined based on the entries in the DDS of origin node 102B. Origin node 102B forwards the delta in the retrieved data to request node 102E along with a message stating that the rest of the data request can be reconstructed from the DDS of request node 102E. Based on the entries in the DDS of request node 102E from when client 106₁₃ requested data from origin 104₄ and on the data retrieved by origin node 102B, request node 102E reconstructs the data requested by client 106₁₂ and forwards it to client 106₁₂.

In a procedure 270, the best request node reconstructs the retrieved data from its own DDS and forwards the reconstructed data to the client. With reference to FIG. 4B, based on the entries in the DDS of request node 102E from when client 106₁₃ requested data from origin 104₄ and on the data retrieved by origin node 102B, request node 102E reconstructs the data requested by client 106₁₂ and forwards it to client 106₁₂. In a procedure 272, the generated WAN optimization network is updated. This is based on the data request handled, which server nodes in the WAN optimization network played a role in handling the data request and includes updating the DDSs of the best request node and the best origin node or the DDS of any other server node which was used in handling the data request. It may also include updating the topology of the WAN optimization network, which server nodes are members of which clusters and updating the caches of the DDSs of the server nodes used in handling the data request. With reference to FIG. 4B, after request node 102E transfers the requested data to client 106₁₃, request node 102E updates its DDS. The entry in its DDS will include information and a data entry related to the data request as well as the actual data transferred. As explained also in FIG. 4C, if another client requests the same data as previously requested by client 106₁₃, then the information and data entry in the DDS of request node 102E may be used to further increase the data transfer rate of retrieving the requested data and providing it to the other client which requested the data.

It will be appreciated by persons skilled in the art that the disclosed technique is not limited to what has been particularly shown and described hereinabove. Rather the scope of the disclosed technique is defined only by the claims, which follow.

1. Method for increasing a data transfer rate for a regular network user, comprising the procedures of:
generating a WAN optimization network of at least two server nodes;
in a network, defining at least two nodes, at least one of said nodes being a client, for requesting data, and at least another one of said nodes being an origin, from which said data is requested from;
said generated WAN optimization network determining a best requesting node for said client based on a data request, said best requesting node being selected from said at least two server nodes which can communicate most efficiently with said client;
establishing a configuration to forward said data request of said client to said generated WAN optimization network;
said client requesting data from said origin by forwarding said data request to said determined best requesting node;
said generated WAN optimization network determining a best origin node, from said at least two server nodes, for retrieving said requested data from said origin according to at least one network identifier resolution of said origin, wherein said best origin node is one of said at least two server nodes which can most efficiently retrieve said requested data from said origin;
said best requesting node forwarding said data request to said best origin node using a first at least one WAN optimization technique;
said best origin node retrieving said requested data from said origin and transferring said retrieved data to said best requesting node using a second at least one WAN optimization technique;
said best requesting node transferring said retrieved data to said client; and
updating said WAN optimization network.

2. The method according to claim 1, wherein said network is selected from the list consisting of:
the Internet;
a WAN;
an intranet; and
a LAN.

3. The method according to claim 1, wherein said client is selected from the list consisting of:
a personal computer;
a workstation;
a smartphone; and
a device capable of accessing the Internet and performing data requests.

4. The method according to claim 1, wherein said origin is selected from the list consisting of:
a website;
a server;
a mail server;
a proxy server;
a cloud server; and
a cloud router.

5. The method according to claim 1, wherein said procedure of determining a best requesting node for said client is executed using at least one heuristic.

6. The method according to claim 5, wherein said at least one heuristic is executed by external software installed on said client.

7. The method according to claim 5, wherein said WAN optimization network further comprises a SOCKS file proxy and wherein said at least one heuristic is executed by said SOCKS file proxy.

8. The method according to claim 5, wherein said WAN optimization network further comprises a DNS server and wherein said at least one heuristic is executed by said DNS server.

9. The method according to claim 5, wherein said at least one heuristic is selected from the list consisting of:
a shortest path of one of said at least two server nodes to said client; and
one of said at least two server nodes having a quickest response time with said client.

10. The method according to claim 1, wherein said procedure of determining a best requesting node for said client is executed based on a performance of said at least two server nodes.

11. The method according to claim 1, wherein said procedure of determining a best requesting node for said client is executed based on a latency of said at least two server nodes.

12. The method according to claim 1, further comprising the procedure of periodically updating said determined best requesting node.

13. The method according to claim 12, wherein said procedure of periodically updating comprises a sub-procedure of determining if a shortest path server node in said WAN optimization network to said client is also a quickest server node in said WAN optimization network to respond to said client.

14. The method of according to claim 1, wherein said procedure of determining a best origin node for retrieving said requested data is executed using at least one heuristic.

15. The method according to claim 14, wherein said at least one heuristic is selected from the list consisting of:
a shortest path of one of said at least two server nodes to said origin; and
a shortest path of one of said at least two server nodes to a proxy server coupled with said origin having a local copy of said requested data.

16. The method according to claim 1, wherein said at least one network identifier resolution is selected from the list consisting of:
Internet protocol (IP) addressing;
domain name system (DNS) addressing;
media access control (MAC) addressing;
NetBIOS over TCP/IP addressing; and
entity identification (EID) addressing.

17. The method according to claim 1, wherein said first at least one WAN optimization technique and said second at least one WAN optimization technique are each selected from the list consisting of:
deduplication;
traffic shaping;
compression;
protocol spoofing;
latency optimization; and
caching.

18. The method according to claim 1, wherein said procedures of determining said best requesting node and said best origin node are executed recursively.

19. The method according to claim 1, wherein said procedures of forwarding said data request to said determined best requesting node and determining said best origin node are executed recursively.

20. The method according to claim 1, further comprising the procedure of said best requesting node pre-fetching said requested data from said origin.

21. The method according to claim 1, further comprising the procedure of said best origin node pre-fetching said requested data from said origin.

22. The method according to claim 1, further comprising the procedure of determining if pre-fetching said requested data by at least one of said best requesting node and said best origin node from said origin increases said data transfer rate.

23. The method according to claim 1, wherein each one of said at least two server nodes comprises a respective distributed data structure (DDS).

24. The method according to claim 23, wherein said respective DDS is selected from the list consisting of:
a distributed hash table;
a distributed graph;
a distributed linked list; and
a distributed array.

25. The method according to claim 23, wherein said respective DDS stores at least one item selected from the list consisting of:
a table of values from which said requested data can be reconstructed;
data necessary for executing at least one of said first at least one WAN optimization technique and said second at least one WAN optimization technique;
configuration information related to said WAN optimization network;
information relating to data handled by one of said at least two server nodes in said WAN optimization network; and
information regarding a topology of said at least two server nodes in said WAN optimization network.

26. The method according to claim 23, wherein said procedure of updating said WAN optimization network comprises updating said respective DDS for each one of said at least two server nodes.

27. The method according to claim 26, wherein said procedure of updating said respective DDS comprises at least one sub-procedure selected from the list consisting of:
storing information in said respective DDS related to data requests recently handled by each one of said at least two server nodes;
updating a topology of said WAN optimization network stored in said respective DDS;
caching data from said requested data in said respective DDS provided said requested data can be cached; and
updating said best requesting node and said best origin node stored in said respective DDS.

28. The method according to claim 1, further comprising the procedure of forming at least one cluster of server nodes in said WAN optimization network, said at least one cluster of server nodes being selected from said at least two server nodes.

29. The method according to claim 28, further comprising the procedures of:
using network analytics to monitor data flow through said WAN optimization network; and
determining membership of each one of said at least two server nodes in said at least one cluster based on said monitored data flow.

30. The method according to claim 28, further comprising the procedure of determining membership of each one of said at least two server nodes in said at least one cluster using at least one decentralized management technique.

31. The method according to claim 28, wherein membership of a server node in said at least one cluster is stored in a distributed data structure (DDS) in said WAN optimization network.

32. The method according to claim 28, wherein said procedure of updating said WAN optimization network comprises updating which server nodes of said at least two server nodes are members of which said at least one cluster.

33. The method according to claim 1, further comprising the procedure of said best origin node retrieving said requested data from a proxy server coupled with said origin.

34. The method according to claim 1, further comprising the procedure of forming at least one cluster of said at least two nodes accessing said WAN optimization network.

35. The method according to claim 1, further comprising the procedure of said best requesting node retrieving said requested data from another one of said at least two server nodes in said WAN optimization network, if said requested data was cached on said another one of said at least two server nodes.

36. The method according to claim 1, further comprising the procedure of said WAN optimization network determining a difference between said data request from said origin by a first one of said at least two nodes and a previous data request from said origin by a second one of said at least two nodes.

37. The method according to claim 1, wherein said procedure of establishing a configuration comprises a device configuration.

38. The method according to claim 1, wherein said procedure of establishing a configuration comprises a non-device configuration.

39. The method according to claim 38, wherein said non-device configuration is selected from the list consisting of:
accessing a SOCKS file proxy;
using DNS; and
using a border gateway protocol (BGP).

40. Method for increasing a data transfer rate for a regular network user, comprising the procedures of:
generating a WAN optimization network of at least two server nodes;
in a network, defining at least two nodes, at least one of said nodes being a client, for requesting data, and at least another one of said nodes being an origin, from which said data is requested from;
said generated WAN optimization network determining a best requesting node for said client based on a data request, said best requesting node being selected from said at least two server nodes which can most efficiently communicate with said client;
establishing a configuration to forward said data request of said client to said generated WAN optimization network;
said client requesting data from said origin by forwarding said data request to said determined best requesting node;
said generated WAN optimization network determining a best origin node, from said at least two server nodes, for retrieving said requested data from said origin according to at least one network identifier resolution of said origin, wherein said best origin node is one of said at least two server nodes which can most efficiently retrieve said requested data from said origin;
said best requesting node forwarding said data request to said best origin node using at least one WAN optimization technique;
said best origin node retrieving said requested data from said origin;
if said retrieved data is cache enabled and has not yet expired, then said best origin node determining if said retrieved data can be reconstructed from said generated WAN optimization network;
said best origin node forwarding a message to said generated WAN optimization network to reconstruct said retrieved data from at least one distributed data structure (DDS);
said best request node reconstructing said retrieved data from its own DDS and transferring said retrieved data to said client; and
updating said WAN optimization network.

41. The method according to claim 40, wherein said procedure of determining if said retrieved data can be reconstructed from said generated WAN optimization network comprises the sub-procedure of determining a difference between said data request of said client to said origin and a previous data request of another client to said origin.

42. The method according to claim 41, further comprising the procedure of said best requesting node reconstructing said retrieved data from its own DDS and from said determined difference.

43. WAN optimization system for use with a network, said network comprising at least two nodes, at least one of said nodes being a client, for requesting data, and at least another one of said nodes being an origin, from which said data is requested from, said WAN optimization system comprising:
at least two server nodes, coupled together so as to transfer data there between using at least one WAN optimization technique;
wherein said WAN optimization system determines a best requesting node and a best origin node, from said at least two server nodes, for said client based on a data request and on at least one network identifier resolution of said origin;
wherein said best requesting node is one of said at least two server nodes which can most efficiently communicate with said client;
wherein said best origin node is one of said at least two server nodes which can most efficiently retrieve said data request from said origin;
wherein said client forwards said data request to said determined best requesting node which forwards said data request to said best origin node using said at least one WAN optimization technique;
wherein said best origin node retrieves said requested data from said origin and transfers it back to said best requesting node, using said at least one WAN optimization technique; and
wherein said best requesting node transfers said retrieved data to said client.
